(19) United States
(12) Patent Application Publication
(10) Pub. No.: US 2014/0052548 A1
(43) Pub. Date: Feb. 20, 2014

(54) SYSTEM AND METHOD FOR AUTOMATED ADVOCATE MARKETING WITH DIGITAL RIGHTS REGISTRATION

(71) Applicant: Maynard L. Dokken, JR., Toronto (CA)

(72) Inventor: Maynard L. Dokken, JR., Toronto (CA)

(21) Appl. No.: 13/945,473

(22) Filed: Jul. 18, 2013

Related U.S. Application Data
(60) Provisional application No. 61/673,012, filed on Jul. 18, 2012.

(51) Int. Cl. G06Q 50/00; G06Q 30/02

(52) U.S. Cl. CPC G06Q 50/01; G06Q 30/0277
USPC 705/14.73

(57) ABSTRACT

A system and method for automated advocate marketing with digital rights registration. A topical semantic indexing platform records and indexes electronic word of mouth (eWom) and multimedia properties to a global content management system. A multi global graph system defines and optimizes commerce between advocates and users. Automated expertise ranking is enabled through indexing of eWom and multimedia properties by topical indexing with performance tracking. A KeyID system provides tracking of marketing through all channels and all media and online including public Key Word discovery. Automated monetization occurs through a buy-sell auction platform and eWom marketing media server with packet, general and Multi-protocol label switching routing and architecture.

This application is the non-provisional application of U.S. Provisional Patent Application No. 61/673,012 filed on Jul. 18, 2012, the content of which is incorporated herein by reference in its entirety.

### FIELD OF INVENTION

The present invention relates to a system for advocate marketing with digital rights registration. Specifically, the present invention provides delivery through user identification and advocate network indexes using all eWom marketing media types and channels with automated buy-sell and trust and expertise systems for monetization.

### BACKGROUND

The internet has been challenged by the need for a true system for indexing multimedia and electronic word of mouth (eWom) properties. This indexing is the foundation of social tracking. The other challenge has been the tracking of marketing campaigns including viral marketing. The current systems utilize single graph profiles to operate platforms. This system does not provide relationship models between characteristics of different graphs but are platform focused. Further, multimedia and electronic word of mouth does not have a platform to register digital rights. This provides limited monetization for user accounts. The predominant method for marketing has been intrusive rather than unobtrusive and has not provided a meaningful value exchange. Additionally, the social media platforms are monolithic and lack the flexibility and openness for users to optimize their information. The social media, membership, and service platforms lack full privacy controls for users as exchange of value for that information is limited or non-existent.

### SUMMARY

The present invention addresses several issues for eWom and multimedia properties including digital rights registration and tracking. It also addresses the need for value exchange for user information.

The invention provides a topical semantic indexing platform that records and indexes electronic word of mouth (eWom) and multimedia properties to a global content management system. A multi global graph system defines and optimizes commerce between advocates and users. Automated expertise ranking is enabled through indexing of eWom and multimedia properties to topical indexing with performance tracking. A KeyID system provides tracking of marketing through all channels and all media and online public key word discovery. Automated monetization occurs through a buy-sell auction platform and eWom marketing media server with packet, general and Multi-protocol label switching routing and architecture. The term automated monetization refers to a systems ability to automatically establish a value of an event, action, trigger, or behavior, of which a preferred embodiment of the process is described herein.

An information and extraction engine creates a topical semantic indexing platform for recording and indexing eWom and multimedia content and properties. The system provides indexing to content management platform and public platform pages for indexing throughout the online network including search engines. An eWag (a multimedia tag) eWom hyperlink is generated through the process of monetization and delivery to a device of the eWom marketing media including a KeyID for global online, semantic and linguistic tracking. The system uses multiple unique global graphs to populate a global relational graph system for optimization of commerce processes.

The digital rights registration, trust and expertise ranking system processes provide monetization through an automated buy-sell auction platform and ranking. An authentication, authorization, and device registration gateway provides authorization and authentication services. An advocate and user graph acquisition and lookup system provides network indexing architecture combined with KeyID universal device discovery. A digital rights registration system provides a record of ownership of digital rights. The topical semantic indexing provides search engines with focused multimedia indexing platform. The buy-sell auction platform provides monetization through an e-procurement purchase system for advertisers, publishers, ad networks, agencies and suppliers. A core logic engine optimizes operation and performance with a polymorphic database and indexing schema. Programmable algorithms are also used for system optimization and management including information retrieval and extraction.

The core logic engine provides modeling and delivery of trust and expertise ranking metrics utilizing viewer input for trust, and topical semantic indexing with performance metrics for expertise calculations. A Next Generation Network (NGN) packet, general and Multi-protocol label switching routing and architecture provides automated delivery of marketing media through all types of networks and platforms.

The combination of the semantic topical indexing, eWag eWom tagging processes, KeyID, probabilistic and non-probabilistic, and multiple global relational graph architecture with online extraction techniques provides a comprehensive tracking of all marketing campaigns including eWom and multimedia.

An application programming interface (API) platform and software development kit (SDK) is integrated into the advocate marketing system for future media, delivery technology, product and service developments.

The present invention further provides a platform that could be licensed. The licensed model and systems could be co-located or hosted at service provider locations.

Various additional features, advantages, services, providers, industries and other factors of the present invention can be more fully appreciated with reference to the detailed description and accompanying drawings.

It is therefore an object of the present invention to address and overcome the shortcomings of the existing systems for indexing and monetizing multimedia and eWom properties.

In accordance with an aspect of an embodiment of the present invention, there is provided a system and method for advocate marketing with digital rights registration. An information and extraction engine can create a topical semantic indexing platform for recording and indexing eWom and multimedia content and properties. The system can provide indexing to content management platform and public platform pages for indexing throughout the online system and search engine. An eWag eWom hyperlink can be generated through the process of monetization and delivery of the eWom marketing media and includes a KeyID for global online and linguistic tracking. The advocate marketing system can use multiple unique global graphs to populate a global relational graph system for optimization of commerce processes. The digital rights registration, trust and expertise ranking processes can provide monetization through an automated buy-sell auction platform and ranking. An authentication, authorization, and device registration gateway can provide authorization and authentication services. An advocate and user graph acquisition and lookup system can provide network indexing architecture combined with KeyID universal device discovery. A digital rights registration system can provide a record of ownership of digital rights. The topical semantic indexing can provide search engines with focused multimedia indexing platform. The buy-sell auction platform can provide monetization through e-procurement purchases from advertisers, publishers, ad networks, agencies and suppliers. A core logic engine can optimize operation and performance with a polymorphic database and indexing schema. Programmable algorithms can be used for system optimization and management, including information retrieval and extraction. The core logic engine can provide modeling and delivery of trust and expertise ranking utilizing viewer input for trust, topical semantic indexing and performance for expertise calculations. An NGN media channel gateway can provide automated delivery of marketing media through all types of networks and platforms. The combination of the semantic topical indexing, eWag eWom tagging processes, KeyID, probabilistic and non-probabilistic, multiple global relational graph architecture with online extraction techniques can provide a comprehensive tracking of all marketing campaigns including eWom and multimedia. An API (application programming interface) platform and SDK (software development kit) can be integrated into the advocate marketing system for future media, delivery technology, product and service developments.

The Advocate Marketing system can be an independent platform for social, membership and service sites.

In a further embodiment, the Advocate Marketing system can utilize an information based KeyID system combined with a KeyID within eWom and multimedia URI and URL's as well as content platforms.

In a further embodiment, the Advocate Marketing system can utilize a Key Word based actionable event discovery process of public and digital Key Words within all messaging, query, eWom and multimedia properties.

In a further embodiment, the Advocate Marketing system can utilize a multiple global graph-based relational graph system.

In a further embodiment, the Advocate Marketing system can utilize a Regularized Latent Semantic Indexing model with Normalization and Sparsing techniques to optimize topical matching and document matching including scores.

In a further embodiment, the Advocate Marketing system can utilize a Regularized Latent Semantic Indexing model with Publisher and Account parameters to facilitate indexing to a content management and publication platform.

In a further embodiment, the Advocate Marketing system can use an aggregate of social, membership, and service contact import or connect programs to populate the Advocate Network database.

In a further embodiment, the Advocate Marketing system can use manual methods to populate the Advocate Network database.

In a further embodiment, the Advocate Marketing system can utilize a unique relational parallel graph-based system of two or more unique global graphs for determining market media type and delivery.

In a further embodiment, the Advocate Marketing system can utilize an eWom template to provide a selection of eWoms for advertisements or placement into the Buy-Sell Auction Platform.

In a further embodiment, the Advocate Marketing system can use an E-Procurement platform.

In a further embodiment, the Advocate Marketing system can use an anonymous device identification which can be combined with a persistent cookie, unique device identifier, or other ID method such as SSO through social, membership or service accounts to deliver accurate Viewer eWoms based on Advocates and Viewer Network profile.

In a further embodiment, the Advocate Marketing system can use anonymous device identification for tracking actionable events of Users including within Viral and Guerilla marketing campaigns.

In a further embodiment, a Keyword instant messaging lookup and Icon placement system can provide viral campaign tracking.

In a further embodiment, a viral edge node indexing system can utilize the information and extraction and retrieval engine to identify routes and results with tracking of real actions from users including instant messages with probabilistic KeyID identification.

In a further embodiment, the Advocate Marketing system can use a Campaign and Viral Marketing Tracking Platform and system for data and map visualization of campaign results.

In a further embodiment, the Advocate Marketing system can use an eWom Marketing Media Platform to add eWoms to any marketing media.

In a further embodiment, the Advocate Marketing system can use an eWom Marketing Media Platform to add eWoms to Search Engine user dialogs and result displays.

In a further embodiment, the Advocate Marketing system can use an eWom Marketing Media Platform to add eWoms to Instant Messaging dialogs and text displays.

In a further embodiment, the Advocate Marketing system can use an eWom Marketing Media Platform to add eWoms to text, voice, and multimedia, and on premises or outdoor presentation devices.

In a further embodiment, the Advocate Marketing system can use an eWom Marketing Media Platform to add eWoms to text, voice, and multimedia to online presentation services such as Display Ads and Mapping services.

In a further embodiment, the Advocate Marketing system can use an E-Procurement and Advocate Buy-Sell Auction Platform for purchase of expertise services including eWoms.

In a further embodiment, the Advocate Marketing Trust and Expertise System can utilize the eWag eWom platform and performance metrics to establish Indexable Expertise Ranking and Viewer, E-Procurement and User Input for Trust Rankings.

In a further embodiment, an E-Procurement Buy-Sell Auction Platform can automatically match eWom listings to Advertisement, Ad Network, Publisher and Agency listings to deliver real time notification of performance metrics through all messaging channels.

In a further embodiment, the Advocate Marketing system can use a Digital Rights Registration of eWoms and Digital Properties such as Virtual Game Characters.

In a further embodiment, the Advocate Marketing system can use a Digital Rights Registration of gaming and virtual world properties within the Buy-Sell Auction Platform, including utilization of the Trust & Expertise Ranking system for valuation of properties.

In a further embodiment, the Advocate Marketing system can use an Automated Listing of Digital Rights Registrations to the Buy-Sell Auction Platform.

In a further embodiment, the Advocate Marketing system can incorporate an Advocate and Viewer Graph system. An Advocate graph can be mapped to a person, place, or thing within a desire and needs partition. A segregated commerce, taste, knowledge and related graph can be incorporated into a global Advocate needs graph to form the basis of discovering the needs of the Viewer.

In a further embodiment, identification methods can be provided for switching trigger metrics using relational global graph architecture.

In a further embodiment, the Advocate Marketing system can use a global Viewer desire graph priority Pop-up to identify needs based on Viewer trending and manual requests.

In a further embodiment, the Advocate Marketing system can utilize an E-Procurement Platform for Advertisers, Publishers, Ad Networks, Agencies, and providers of expertise services.

In a further embodiment, the Advocate Marketing system can utilize a Device and Application Discovery Engine utilizing KeyIDs.

In a further embodiment, the Advocate Marketing system can utilize an anonymous marketing intelligence analysis platform to display current advertising content delivery profiles, which can be edited by the Viewer through activation by clicking or mouse over of an Icon, Pop-Up, or similar dialog activation model, utilizing anonymous, ID or Device Discovery Engine services.

In a further embodiment, the Advocate Marketing system can use a global cookie tracking system to provide options to allow cookies that are delivering compensatory or matching services or payments in turn for information extracted by those information acquisition services.

In a further embodiment, the Advocate Marketing system can utilize a customized settings module for aggregated and segregated Trust and Expertise Ranking for Advocate and E-Procurement services and Buy-Sell Auction processes.

In a further embodiment, the Advocate Marketing core logic engine can utilize a programmable business logic module as well as business intelligence polymorphic database schema.

In a further embodiment, the Advocate Marketing core logic engine can utilize a programmable algorithm and indexing module and system as well as system intelligence polymorphic algorithm and indexing system.

In a further embodiment, the Advocate Marketing system can use a core logic database and indexing and polymorphic schema functions for real time adjustment and updates of Advocate and Viewer global graph definitions.

In a further embodiment, the Advocate Marketing system can use a core logic database and indexing and polymorphic schema functions for real time customization and definition of algorithms for optimization of information extraction and retrieval processes.

In a further embodiment, the Advocate Marketing system can use KeyID marketing tracking to populate the Advocate Network database with online and physical media linking to eWoms actions such as click through and eWom mouse over with Advocate Network lookup.

In a further embodiment, the Advocate Marketing system can use user-generated Mapping Systems for Integration of eWoms and eWom Deals onto user loaded multimedia viewers at street level from Advocates and E-Procurement providers for virtual placement of advertising and marketing media.

In a further embodiment, the Advocate Marketing system can use a Virtualization Platform to add eWoms to physical marketing media utilizing a scan coding from mobile devices through SKU or QR codes to activate digital wireless and wired online presentations of Advocate eWoms.

In a further embodiment, the Advocate Marketing system can use a Virtualization Platform to add eWoms to Virtual and Gaming environments and MMOG (massively multiplayer online game) and MMORPG (massively multiplayer online role-playing game) to display, voice, text and multimedia presentation within those environments.

In a further embodiment, the Advocate Marketing system can use an eWom Marketing Media Platform for registration of Custom Virtualization processes by E-Procurement and Advocate users, including Automated Listing on the Digital Rights Buy-Sell Auction Expertise Platform.

In a further embodiment, the Advocate Marketing system can use Pop-Up eWom menus on a URL, a website, or other services, including message or digital media platforms or services.

In a further embodiment, the Advocate Marketing system can use a menu system for delivery of single and multiple eWoms onto marketing media and services applications including search engines, instant messaging platforms, websites and mapping applications.

In a further embodiment, the Advocate Marketing system can use an Icon system for delivery of single and multiple eWoms onto marketing media and services applications including search engines, instant messaging platforms, websites and mapping applications.

In a further embodiment, the Advocate Marketing system can use a Multicast IMS, NGN or Multi-Channel Delivery Platform for E-Procurement registration of Advocate marketing delivery.

In a further embodiment, the Advocate Marketing system can use a Multicast or Multi-Channel Delivery API and SDK Development Platform.

In a further embodiment, the Advocate Marketing system can use a Multicast or Multi-Channel Delivery Platform for detection and selection of network channels for delivery of eWoms for Virtualization onto Marketing Media, Virtualized eWoms on Marketing Media, Advertising Network connections, Publishing Systems integration, and all Advocate Marketing services, including through connection protocols created by SDK and APIs.

In a further embodiment, the Advocate Marketing system can use a Multicast or Multi-Channel Delivery Platform for delivery of eWoms to Advertising or Content Delivery Platforms.

In a further embodiment, the Advocate Marketing system can use an API Platform Layer for integration service into Enterprise Platforms.

In a further embodiment, the Advocate Marketing system can use a Multicast or Multi-Channel Delivery Platform for detection and selection of network channels for delivery of eWoms for Virtualization onto Marketing Media, Virtualized eWoms with Marketing Media, Advertising Network connections, Publishing Systems and all Advocate Marketing services, including connections through wire and wireless services and devices.

In a further embodiment, the Topical Semantic Index System can crawl and track all digital properties and updates using the KeyID and eWag eWom link, which displays update data on the eWag page, <ewag.domain.com/publisher>.

In yet a further embodiment, a core logic engine polymorphic indexing and database schema function can create pages based on new and existing publishers and eWag accounts. epost accounts can either be integrated into the eWag pages by reference within the posting account, or by input of an epost hyperlink. epost accounts can be indexed to eWag accounts by input of an eWag hyperlink within the site post. ePost and eWag can be indexed when crawled and mapped in a separate <epost.domain.com/site/publisher> or <ewag.domain.com/publisher> webpage.

In a further embodiment, the Advocate Marketing system can use auto dynamic html links within eWag and eWom posts, including auto hyperlinks back to the publisher listings page, which can be either the ewag or the epost domain, which also provides a rating as to the Expertise level of the Multi-media or eWom publisher through a ranking system utilizing topical indexing and RLSI or similar topical indexing process.

In a further embodiment, the Advocate Marketing eWag, eWagged and eWagging system can use a content management display, which can index and map epost and ewag published and posted digital media.

In a further embodiment, the Advocate Marketing system can use an identification system to link epost and ewag webpages.

In a further embodiment, the Advocate Marketing system can use a coupon and deal delivery eWom through all methods and channels.

In a further embodiment, the Advocate Marketing system can provide Privacy settings for delivery of eWoms to individuals, or to segregated and defined groups by Viewers and Advocates.

In a further embodiment, the Advocate Marketing system can use fraud detection processes within the information extraction and retrieval system to identify threats including utilization of Sybil Guard or similar processes.

In a further embodiment, the Advocate Marketing system can use the information extraction and retrieval system to identify unauthorized use of Registered eWoms.

In a further embodiment, the Advocate Marketing system can use an eWag pinning system to manually add people, places or things to the Advocate, E-Procurement or Viewer Wish/Want/Get-List account.

In a further embodiment, the Advocate Marketing system can use a Mobile SKU, QR, Code and picture Scanning System to add a person, place or thing to the Advocate, E-Procurement or Viewer Wish/Want/Get-List account.

In a further embodiment, the Advocate Marketing system can use wired and wireless methods to add a person, place or thing to the Advocate, E-Procurement or Viewer Wish/Want/Get-List account.

In accordance with an aspect of a further embodiment of the present invention, there is provided a system for advocate marketing with digital rights registration. The system may comprise:

an information and extraction engine that can create a topical semantic indexing platform for recording and indexing eWom and multimedia content and properties;

an Information and extraction engine that can provide information for indexing of a content management platform and public platform pages for indexing throughout an online system;

an eWag eWom hyperlink that can be generated through the process of monetization and delivery of an eWom marketing media and includes a KeyID for global online and linguistic tracking;

an advocate marketing system that can use at least one multiple global graph to populate a global relational graph system for optimization of commerce processes;

a digital rights registration and a trust and expertise ranking process that can provide monetization through an automated platform;

a gateway that can provide authorization and authentication services;

an advocate and user graph acquisition and lookup system that can provide network indexing architecture;

a digital rights registration system that can provide a record of ownership of digital rights;

a topical semantic indexing that can provide the online system with a focused multimedia indexing platform;

a platform that can provide monetization through e-procurement purchases;

a core logic engine that can optimize operation and performance with a database and indexing schema;

programmable algorithms that can be used for system optimization and management;

a core logic engine that can provide modeling and delivery of the trust and expertise ranking using viewer input for a trust ranking, and topical semantic indexing that can be used for an expertise ranking; and

a media channel gateway that can provide automated delivery of marketing media.

In a further embodiment, the combination of the semantic topical indexing, the eWag eWom hyperlink, the KeyID, and the at least one multiple global graph can provide a tracking of marketing campaigns.

In a further embodiment, an Application Programming Interface (API) platform and Software Development Kit (SDK) can be integrated into the advocate marketing system.

In a further embodiment, the Advocate Marketing system can be an independent platform for social, membership and service sites.

In a further embodiment, the Advocate Marketing system can use an information based KeyID system combined with a KeyID within eWom and multimedia URI and URL's, as well as content platforms.

In a further embodiment, the Advocate Marketing system can use a Key Word based actionable event discovery process of public and digital Key Words within all messaging, query, eWom and multimedia properties.

In a further embodiment, the Advocate Marketing system can utilize a multiple global graph-based relational graph system.

In a further embodiment, the Advocate Marketing system can utilize a Regularized Latent Semantic Indexing model with Normalization and Sparsing techniques to optimize topical matching and document matching.

In a further embodiment, the Regularized Latent Semantic Indexing model can include scores related to the topical matching and document matching.

In a further embodiment, the Advocate Marketing system can utilize a Regularized Latent Semantic Indexing model with Publisher and Account parameters to facilitate indexing to a content management and publication platform.

In a further embodiment, the Advocate Marketing system can use an aggregate of social, membership, and service contact import or connect programs to populate an Advocate Network database.

In a further embodiment, the Advocate Marketing system can use an aggregate of social, membership, and service contact import or connect programs to populate a Viewer Network database.

In a further embodiment, the Advocate Marketing system can use manual methods to populate the Advocate Network database.

In a further embodiment, the Advocate Marketing system can use manual methods to populate the Viewer Network database.

In a further embodiment, the Advocate Marketing system can utilize a unique relational parallel graph-based system of at least one unique global graph for determining a market media type.

In a further embodiment, the Advocate Marketing system can utilize an eWom template to provide a selection of eWoms for Ads or placement into the Automated Platform.

In a further embodiment, the Advocate Marketing system can use an E-Procurement platform for Request of Information, Request for Proposal, and Request for Buy-Sell Quotation.

In a further embodiment, the Advocate Marketing system can use an anonymous device identification that can be combined with a persistent cookie, unique device identifier, or other identification methods through social, membership or service accounts to deliver a Viewer eWom based on the Advocates Network database.

In a further embodiment, the Advocate Marketing system can use an anonymous device identification that can be combined with a persistent cookie, unique device identifier, or other identification methods through social, membership or service accounts to deliver a Viewer eWom based on the Viewer Network database.

In a further embodiment, the Advocate Marketing system can use anonymous device identification for tracking actionable events of Users within Viral and Guerilla marketing campaigns.

In a further embodiment, a Keyword instant messaging lookup and Icon placement system can provide viral campaign tracking.

In a further embodiment, a viral edge node indexing system can use the information and extraction engine to identify and track real actions from users, including instant messages with KeyID identification.

In a further embodiment, the Advocate Marketing system can use a Campaign and Viral Marketing Tracking Platform to produce a visualization of campaign results.

In a further embodiment, the Advocate Marketing system can use an eWom Marketing Media Platform to add eWoms to a marketing media.

In a further embodiment, the Advocate Marketing system can use an eWom Marketing Media to add eWoms to Search Engine user dialogs and result displays.

In a further embodiment, the Advocate Marketing system can use an eWom Marketing Media to add eWoms to at least one member of the group, consisting of: Instant Messaging dialogs, text displays, text, voice, multimedia, on premise presentation devices, and outdoor presentation devices.

In a further embodiment, the Advocate Marketing system can use an eWom Marketing Media to add eWoms to text, voice, multimedia and online presentation services, such as Display Ads and Mapping services.

In a further embodiment, the Advocate Marketing systems can use an E-Procurement and an Advocate Buy-Sell Auction Platform for purchase of expertise services, including eWoms.

In a further embodiment, the Advocate Marketing Trust and Expertise System can utilize the eWag eWom platform and performance metrics to establish Indexable Expertise Ranking and Viewer, E-Procurement and User Input for Trust Rankings.

In a further embodiment, an E-Procurement Buy-Sell Auction Platform can automatically match eWom listings to Advertisement, Ad Network, Publisher and Agency listings to deliver real time notification of performance metrics through a messaging channel.

In a further embodiment, the Advocate Marketing system can use a Digital Rights Registration of eWoms and Digital Properties, such as Virtual Game Characters.

In a further embodiment, the Advocate Marketing system can use a Digital Rights Registration of gaming and virtual world properties within a Buy-Sell Auction Platform, including utilization of the Trust and Expertise Ranking for valuation of properties.

In a further embodiment, the Advocate Marketing system can use an Automated Listing of Digital Rights Registrations.

In a further embodiment, the Advocate Marketing system can incorporate an Advocate and Viewer Graph system, wherein an Advocate graph is mapped to a person, place, or thing within a desire and needs partition, and at least one segregated graph is incorporated into a global Advocate needs graph.

In a further embodiment, identification methods for switch trigger metrics can use relational global graph architecture.

In a further embodiment, the Advocate Marketing system can use a global Viewer desire graph priority Pop-up to identify needs based on Viewer trending and manual requests.

In a further embodiment, the Advocate Marketing system can utilize an E-Procurement Platform for Advertisers, Publishers, Ad Networks, Agencies, and providers of expertise services.

In a further embodiment, the Advocate Marketing system can utilize a Device and Application Discovery Engine using the KeyID.

In a further embodiment, the Advocate Marketing system can utilize an anonymous marketing intelligence analysis platform to display current advertising content delivery profiles, wherein the current advertising content delivery profiles can be edited by a Viewer.

In a further embodiment, the Advocate Marketing system can use a global cookie tracking system to provide options to allow cookies that are delivering compensatory or matching services or payments in turn for information extracted by those information acquisition services.

In a further embodiment, the core logic engine can utilize a programmable business logic module and at least one business intelligence polymorphic database schema.

In a further embodiment, the core logic engine can utilize a programmable algorithm, an indexing module, and a system intelligence polymorphic algorithm and indexing system.

In a further embodiment, the Advocate Marketing system can use a core logic database and at least one indexing and polymorphic schema functions for adjustment of the at least one multiple global graph.

In a further embodiment, the Advocate Marketing system can use a core logic database and at least one indexing and polymorphic schema function for real time customization and definition of algorithms for optimizing information extraction and retrieval processes.

In a further embodiment, the Advocate Marketing system can use a KeyID marketing tracking to populate the Advocate Network database with online and physical media linking eWom actions, such as click through and eWom mouse over, with an Advocate Network lookup.

In a further embodiment, the Advocate Marketing system can use at least one user generated Mapping System for Integration of eWoms and user-loaded multimedia viewers from Advocates and E-Procurement providers for virtual placement of advertising and marketing media.

In a further embodiment, the Advocate Marketing system can use a Virtualization Platform to add eWoms to physical marketing media utilizing a scan coding from mobile devices by SKU or QR codes to activate digital online presentations of eWoms.

In a further embodiment, the Advocate Marketing system can use a Virtualization Platform to add eWoms to a Virtual Gaming environment to display voice, text and multimedia presentation within the Virtual Gaming environment.

In a further embodiment, the Advocate Marketing system can use an eWom Marketing Media Platform for registration of at least one Custom Virtualization process by users, including Automated Listing on a Digital Rights Buy-Sell Auction Expertise Platform.

In a further embodiment, the Advocate Marketing system can use a Pop-Up eWom menu.

In a further embodiment, the Advocate Marketing system can use a menu system for delivery of eWoms onto marketing media and services applications.

In a further embodiment, the Advocate Marketing system can use an Icon system for delivery of eWoms onto marketing media and services applications.

In a further embodiment, the Advocate Marketing system can use a Multicast IMS, NGN or Multi-Channel Delivery Platform.

In a further embodiment, the Advocate Marketing system can use a Multicast or Multi-Channel Delivery API and SDK Development Platform.

In a further embodiment, the Advocate Marketing system can use a Multicast or Multi-Channel Delivery Platform for detection and selection of network channels for delivery of eWoms for Virtualization onto Marketing Media, Virtualized eWom's on Marketing Media, Advertising Network connections, Publishing Systems integration and Advocate Marketing services, including through connection protocols created by SDK and APIs.

In a further embodiment, the Advocate Marketing system can use a Multicast or Multi-Channel Delivery Platform for delivery of eWoms to Advertising and Content Delivery Platforms.

In a further embodiment, the Advocate Marketing system can use an API Platform Layer.

In a further embodiment, the Advocate Marketing system can use a Multicast or Multi-Channel Delivery Platform for detection and selection of network channels for delivery of eWoms for Virtualization onto Marketing Media, Virtualized eWoms with Marketing Media, Advertising Network connections, Publishing Systems and Advocate Marketing services.

In a further embodiment, the Topical Semantic Indexing platform can track digital properties, including updates, using the KeyID and eWag eWom hyperlink that displays data on an eWag webpage.

In a further embodiment, the core logic engine can create pages based on at least one account.

In a further embodiment, the Advocate Marketing system can use at least one auto dynamic html link within at least one post, further providing a rating of an Expertise level of an eWom publisher using a ranking system that can utilize a topical indexing process.

In a further embodiment, the Advocate Marketing system can use a content management display to index and map epost and ewag published and posted digital media.

In a further embodiment, the Advocate Marketing system can use an identification system to link epost and ewag webpages.

In a further embodiment, the Advocate Marketing system can use a coupon and deal delivery eWom.

In a further embodiment, the Advocate Marketing system can provide Privacy settings for delivery of at least one eWom.

In a further embodiment, the Advocate Marketing system can use fraud detection processes within the information and extraction engine to identify threats, including utilization of Sybil Guard.

In a further embodiment, the Advocate Marketing system can use the information and extraction engine to identify unauthorized use of at least one Registered eWom.

In a further embodiment, the Advocate Marketing system can use an eWag pinning system to manually add a person, place or thing to a Wish/Want/Get-List account.

In a further embodiment, the Advocate Marketing system can use a Mobile SKU, QR, Code and picture Scanning System to add a person, place or thing to a Wish/Want/Get-List account.

In a further embodiment, the Advocate Marketing system can use wired and wireless methods to add a person, place or thing to a Wish/Want/Get-List account.

In a further embodiment, the gateway can be an authentication, authorization, and device registration gateway.

In a further embodiment, the advocate and user graph acquisition and lookup system can provide networking indexing architecture combined with a KeyID universal device discovery.

In a further embodiment, the online system can include a search engine.

In a further embodiment, the at least one e-procurement purchases can be from advertisers, publishers, ad networks agencies and suppliers.

In a further embodiment, the database and indexing schema can be a polymorphic database schema.

In a further embodiment, the media channel gateway can be an NGN media channel gateway.

In a further embodiment, the marketing campaigns can include eWoms and multimedia.

### BRIEF DESCRIPTION OF THE DRAWINGS

To provide a more complete understanding of the exemplary embodiments, reference is now made to the appended drawings. These drawings should not be construed as limiting, but are intended to be exemplary only.

FIG. 1 is a Generalized Description of the Advocate Marketing System of the invention in accordance with various embodiments described herein.

FIG. 2 is a generalized description of the Core Logic Engine with Index and Database Mapping, Algorithm Programming, Trust and Expertise Ranking, Mean Average Precision, SybilGuard, and Global Graph Management of the invention in accordance with various embodiments described herein.

FIG. 3 is a generalized diagram of the Online Trust and Expertise Ranking settings of the invention in accordance with various embodiments described herein,

FIG. 4 is a generalized overview of the Information Retrieval and Extraction with eWom Media Discovery and Indexing through RLSI of the invention in accordance with various embodiments described herein.

FIG. 5 is a generalized diagram of the eWag eWom Marketing Media Database with Content Management Platform of the invention in accordance with various embodiments described herein.

FIG. 6 is a generalized description of an Authentication, Authorization and Device Registration Gateway of the invention in accordance with various embodiments described herein.

FIG. 7 is a generalized description of Advocate and Viewer Accounts, with Multi Global Graph and Network Acquisition, and Relationship system of the invention in accordance with various embodiments described herein.

FIG. 8 is a generalized description of a Digital Rights Registration System with eWom Marketing Media Indexing to eWag of the invention in accordance with various embodiments described herein.

FIG. 9 is a generalized description of a Buy-Sell Auction Platform with E-Procurement of the invention in accordance with various embodiments described herein.

FIG. 10 is a generalized view of Advocate & Viewer eWom Network Accounts, Devices & Applications Auto Population Processes of the invention in accordance with various embodiments described herein.

FIG. 11 is a generalized description of a User, Device Discovery Gateway with eWom Marketing Media Lookup of the invention in accordance with various embodiments described herein.

FIG. 12 is a generalized description of a Media Gateway for Delivery and Routing of eWom Marketing Media of the invention in accordance with various embodiments described herein.

FIG. 13 is a generalized description of an eWom Marketing Media Server with API (Application Programming Interface) Platform with Discovery and Routing Services of the invention in accordance with various embodiments described herein.

FIG. 14 is a generalized description of a Viral and Marketing Tracking System with Double-Hermeneutics and Semantic Services of the invention in accordance with various embodiments described herein.

FIG. 15 is a simplified diagram of the Website Display Ads Virtualized and URL Pop-up eWoms of the invention in accordance with a specific embodiment described herein.

FIG. 16 is a simplified diagram of a Mobile Wireless Virtualization of eWoms, Icons, eWom Menus within an Instant Messaging Application of the invention in accordance with a specific embodiment described herein.

FIG. 17 is a simplified diagram of the Search Engine Virtualization of eWoms, Icons, and eWom Menus of the invention in accordance with a specific embodiment described herein.

FIG. 18 is a simplified diagram of a News Feed Virtualization of eWoms, Icons, and eWom Menus of the invention in accordance with a specific embodiment described herein.

FIG. 19 is a simplified diagram of E-Mail and Many-to-Many applications Virtualization of eWoms, Icons, and eWom Menus of the invention in accordance with a specific embodiment described herein.

FIG. 20 is a simplified diagram of a Mapping Application of Virtualization of eWoms, Icons, and eWom Menus through Mouse Over or Touch Screen Activation of the invention in accordance with a specific embodiment described herein.

FIG. 21 is a simplified diagram of a Voice eWom application in a motor vehicle of the invention in accordance with a specific embodiment described herein.

FIG. 22 is a simplified diagram of a Digital Billboard and Outdoor Ad Display Virtualization of eWoms and Mobile Devices Icons, eWom and eWom Menus of the invention in accordance with a specific embodiment described herein.

FIG. 23 is a simplified diagram of the TV eWom recommendation and Audio Watermarking Activation of Virtualization of eWoms, Icons, and eWom Menus of the invention in accordance with a specific embodiment described herein.

FIG. 24 is a simplified diagram of a Gaming and Virtual Environment Virtualization of eWoms, Icons, and eWom Menus of the invention in accordance with a specific embodiment described herein.

FIG. 25 is a simplified diagram of the Physical Brochure to Activation of Virtualization of eWoms, Icons, and eWom Menus on a Landing Page or Website of the invention in accordance with a specific embodiment described herein.

FIG. 26 is a simplified diagram of a Membership Person, Place or Thing Site with Private eWom Displays Virtualization of eWoms, Icons, and eWom Menus of the invention in accordance with a specific embodiment described herein.

FIG. 27 is a simplified diagram of the Voice Advocate eWom system with Virtualization of eWom Menus of the invention in accordance with a specific embodiment described herein.

FIG. 28 is a simplified diagram of the Get/Want/Wish-List SKU, QR, Code or Scan Mobile system for placement of Person, Place or Thing into the User Account of the invention in accordance with a specific embodiment described herein.

### DETAILED DESCRIPTION

The invention provides a topical semantic indexing platform records and indexes electronic word of mouth (eWom) and multimedia properties to a global content management system. A multi global graph system defines and optimizes commerce between advocates and users. Automated expertise ranking is enabled through indexing of eWom and multimedia properties to topical indexing with performance tracking. A KeyID system provides tracking of marketing through all channels and all media and online public key word discovery. Automated monetization occurs through a buy-sell auction platform and eWom marketing media server with packet, general and Multi-protocol label switching routing and architecture.

An information and extraction engine creates a topical semantic indexing platform for recording and indexing eWom and multimedia content and properties. The system provides indexing to content management platform and public platform pages for indexing throughout the online network including search engines. An eWag eWom hyperlink is generate through the process of monetization and delivery of the eWom marketing media and includes a KeyID for global online, semantic and linguistic tracking. In one embodiment of the present invention, the advocate marketing system uses a global needs graph for the advocate and a desire global desire graph for the user or viewer. These multiple unique global graphs populate a global relational graph system for optimization of commerce processes.

The digital rights registration, trust and expertise ranking system processes provide monetization through an automated buy-sell auction platform and ranking. An authentication, authorization, and device registration gateway provides authorization and authentication services. An advocate and user graph acquisition and lookup system provides network indexing architecture combined with KeyID universal device discovery. A digital rights registration system provides a record of ownership of digital rights. The topical semantic indexing provides search engines with a focused multimedia indexing platform. The buy-sell auction platform provides monetization through an e-procurement purchase system for advertisers, publishers, ad networks, agencies and suppliers. A core logic engine optimizes operation and performance with a polymorphic database and indexing schema. Programmable algorithms are also used for system optimization and management including information retrieval and extraction.

The core logic engine provides modeling and delivery of trust and expertise ranking metrics utilizing viewer input for trust, and topical semantic indexing with performance metrics for expertise calculations. A Next Generation Network (NGN) media channel gateway provides automated delivery of marketing media through all types of networks and platforms.

The combination of the semantic topical indexing, eWag eWom tagging processes, KeyID, probabilistic and non-probabilistic, and multiple global relational graph architecture with online extraction techniques provides a comprehensive tracking of all marketing campaigns including eWom and multimedia.

An application programming interface (API) platform and software development kit (SDK) is integrated into the advocate marketing system for future media, delivery technology, and product and service developments.

Combined with the other features of this invention this open platform will enable opportunities for existing platforms that are currently unavailable.

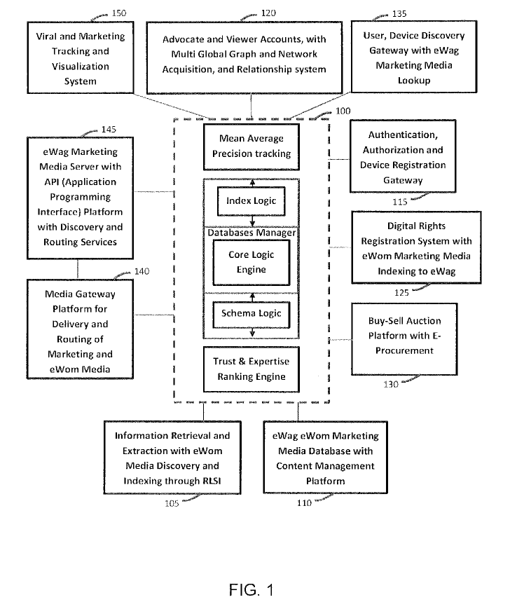

Referring to FIG. 1, a generalized description of the Advocate Marketing System of the invention in accordance with various embodiments is illustrated, comprising of: a Core Logic Engine with Index and Database Mapping, Algorithm Programming, Trust and Expertise Ranking, Mean Average Precision, SybilGuard, and Global Graph Management 100; Information Retrieval and Extraction with eWom Media Discovery and Indexing through RLSI 105; an eWag eWom Marketing Media Database with Content Management Platform 110; an Authentication, Authorization and Device Registration Gateway 115; Advocate and Viewer Accounts, with Multi Global Graph and Network Acquisition, and Relationship system 120; a Digital Rights Registration System with eWom Marketing Media Indexing to eWag 125; a Buy-Sell Auction Platform with E-Procurement 130; a User, Device Discovery Gateway with eWag Marketing Media Lookup 135; a Media Gateway Platform for Delivery and Routing of Marketing and eWom Media 140; an eWag Marketing Media Server with API (Application Programming Interface) Platform with Discovery and Routing Services 145; and a Viral and Marketing Tracking and Visualization System 150.

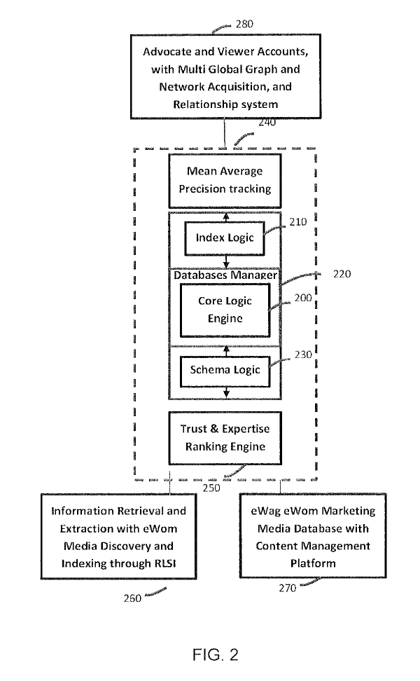

Referring to FIG. 2, a generalized description of the Core Logic Engine with Index and Database Mapping, Algorithm Programming, Trust and Expertise Ranking, Mean Average Precision, SybilGuard, and Global Graph Management of the invention in accordance with various embodiments of the invention is illustrated, comprising of: The Core Logic Engine 200 which has two models, one being business logic and the other learning logic or artificial intelligence logic, works to manage and optimize information, data and indexing mapping and polymorphic processes. Core logic functions relate to: regularized latent semantic indexing 210; programmable algorithms 220, polymorphic database schemas 230; mean average precision 240; and trust and expertise rankings and optimization of system processes. The core logic engine also supports SybilGuard which protects against multiple accounts from the same user in core graphs.

Key information stores include: the Information Retrieval and Extraction with eWom Media Discovery and Indexing through RLSI 260; eWag eWom Marketing Media Database with Content Management Platform 270; and the Advocate and Viewer Accounts, with Multi Global Graph and Network Acquisition, and Relationship system 280.

The combination of existing semantic and resource description framework (RDF) Schema with a new world publisher eWom, posts system provides the ability to understand and deliver solutions based on this indexing system with a traditional approach to a complex condition, real world structure with new world properties. Topical indexing can include any form of property, including ontology associated with eWom posts or topics. It is a simple structure but provides unlimited definitions. A combination of RDF Schema with publisher naming provides search systems with new technology to index and relate eWoms and multimedia properties to a topic and expertise.

The indexing system utilizes topic modeling with a third parameter called publisher. It has been demonstrated that topic modeling is useful for knowledge discovery, relevance ranking in search, and document classification.

The regularized latent semantic indexing (“RLSI”) provides the platform for multimedia and eWom retrieval and extraction. Including a third parameter publisher indexing, the mapping generates the content for the eWag content platform 270 through the information and retrieval extraction system.

RLSI uses regularization rather than orthogonality to constrain the solutions. This provides the potential or parallel processing and optimized the system processes. The key ingredient of this method is to make the formulation of learning decomposable and thus make the process of learning parallelizable.

In a preferred embodiment of the present invention, RLSI formalizes topic modeling which can be decomposed into multiple sub-optimization problems and optimized in parallel via MapReduce in the Hadoop information and retrieval system 260. Adopting l1 norm on topics and l2 norm on document representations creates a model with compact and readable topics and useful for retrieval.

In a further preferred embodiment, a quadratic loss function in statistics and decision theory maps an event onto a real number intuitively representing parameter estimation, and the event is the difference between estimated and true values for that instance of data.

A topic model represents the relationship between terms and documents through latent topics. A topic is defined as a probability distribution of terms or a cluster of weighted terms. A document is then viewed as a bag of terms generated from a mixture of latent topics. A third parameter is incorporated into the mapping or MapReduce process being the digital registration number or publisher which is defined as the account owner. This has commonality to blog and review posts. With this process the system is able to crawl and index eWom posts and reviews of multimedia to define the object which is incorporated into the KeyID Indexing.

RLSI text collection is represented as a term-document matrix, where each entry represents a term frequency-inverse document frequency (tf-idf) score of a term in a document. The term-document matrix is then approximated by the product of two base matrices: the term-topic matrix which represents the latent topics with terms and the topic-document matrix which represents the documents with topics and then applied again to a publisher term-topic matrix.

The document-term matrix or term-document matrix describes the frequency of terms that occur in the collection of eWoms or posts. The document-term matrix rows correspond to documents or posts in the collection and columns correspond to terms. There are various schemes known in the art for determining the value that each entry in the matrix should take. One scheme, tf-idf, is useful in the field of natural language processing and used for the KeyID Keyword tracking.

One of the simplest ranking functions is computed by summing the tf*idf for each query term. The tf*idf weight becomes a numerical statistic which reflects how important a word is to a document in a collection or corpus and assists in identifying the topical weight within the corpus of posts. The tf-idf value increases proportionally to the number of times a word appears in the eWoms, posts or document, and offset by the frequency of the word in the corpus, which helps to control for the fact that some words are generally more common than others. As well tr*idf is used for stop-words filtering in various subject fields including text summarization and classification.

RLSI makes it possible to decompose the learning problem into multiple sub-optimization problems and conduct learning in parallel. This relates to the regularization versus othogonality. Specifically, for both base matrix term-topic and topic-document, the update in each iteration is decomposed into many sub-optimization problems. This process also applies to the indexing of the MapReduce results for creation of eWag content within the eWag indexing system.

The RLSI MapReduce system maps sub-optimization problems over multiple processors and merges the results from the processors. During this process, documents, terms, KeyID, eWag and other processes are distributed as well and processed automatically with publisher or account properties mapped and weighted. Table of Notations and example Algorithms below. The Algorithms provided are merely exemplary and are not to be understood as limiting the present invention.

TABLE 1
Table of notations.

Notation Meaning
M Number of terms in vocabulary
N Number of documents in collection
K Number of topics
D ∈ RM × N Term-document matrix [d1, • • • , dN]
dn The nth document
dmn Weight of the mth term in document dn
U ∈ RM × K Term-topic matrix [u1, • • • , uK]
uk The kth topic
umk Weight of the mth term in topic uk
P ∈ RM × K Publisher-topic matrix [u1, • • • , uK]
uk The kth topic
umk Weight of the mth term in topic uk
V ∈ RK × N Topic-document matrix [v1, • • • , vN]
vn Representation of dn in the topic space
vkn Weight of the kth topic in vn
A ∈ RK × N Account-document matrix [a1, • • • , aN]
an Representation of dn in the publisher space
akn Weight of the kth publisher in vn

Algorithm 1 Regularized Latent Semantic Indexing

Require: D ε RM×N
1: V(0) ε RK×N ← random matrix
2: for t = 1 : T do
3: U(t) ← UpdateU(D,V(t−1))
4: V(t) ← UpdateV(D,U(t))
5: end for
6: return U(T),V(T)

Algorithm 3 UpdateU

M×N, V ε RK×N
1: S ← VVT
2: R ← DVT
3: for m = 1 : M do
4: ⁻um ← 0
5: repeat
6: for k = 1 : K do
7: wmk ← rmk − Σ
l,k skluml
8: umk ← (|wmk|−12
λ1)+sign(wmk)
skk
9: end for
10: until convergence
11: end for
12: return U

Algorithm 3 UpdateP

M×N, V ε RK×N
1: S ← VVT
2: R ← DVT
3: for m = 1 : M do
4: ⁻um ← 0
5: repeat
6: for k = 1 : K do
7: wmk ← rmk − Σ
l,k skluml
8: umk ← (|wmk|−12
λ1)+sign(wmk)
skk
9: end for
10: until convergence
11: end for
12: return P

Algorithm 4 UpdateV

Require: D ε RM×N, U ε RM×K
1: Σ ←
(
UTU + λ2l
)−1
2: Φ ← UTD
3: for n = 1 : N do
4: vn ← Σφn, where φn is the nth column of Φ
5: end for
6: return V
for n = 1, . . . , N. It is a standard l

Algorithm 4 UpdateA

Require: D ε RM×N, U ε RM×K
1: Σ ←
(
UTU + λ2l
)−1
2: Φ ← UTD
3: for n = 1 : N do
4: pn ← Σφn, where φn is the nth column of Φ
5: end for
6: return A
for n = 1, . . . , N. It is a standard l

A Mean Average Precision (MAP) tracking system 240 provides the system with a measurement of results and is specifically designed to optimize the Information Retrieval and Extraction System 260. Specifically, the MAP provides a record of quality of results from the indexing or a corpus of eWom virtualized marketing media, posts or other opinion based ratings. It is used by the core logic engine as a learning directory for optimization of all information services.

Other core processes include learning processes related to programmable algorithms. The RLSI system allows the core logic engine to analyze queries to deliver to the jobs tracking engine within the information retrieval and extraction system 260. Programming parameters are based on datasets that are not complete and discovery of new publishers, accounts, eWom and posting corpus.

The core logic engine database control schema utilizes a subtype polymorphism or inclusion polymorphism wherein the table or record name may denote instances of many different classes as long as they are related by some common super class and thus can be handled via a common interface. This enables an efficient model to populate and evolve the publisher, eWag, eWom, post and eWom corpus sub-properties databases.

This sub-properties database is used by the core logic engine to identify trends, to learn more about eWom corpus, this combination of semantics and ontology at the sub-properties or sub-optimized level further defines needs and desires of users. It also provides the fourth level of analysis which defines the monetization opportunities of advocates.

Many of these sub-property factors provide weights of the eWom monetization opportunities and are used to calculate and produce more accurate and concise scores, rules, definitions, data schema and algorithms based on the totality of this information which is requested information retrieval and extraction engine. This system provides for the ontological and semantic population of sub-properties models associated with eWom corpus. This system can provide both learning processes as well structured profiles of users such as needs based and desire based.

The User Account Indexing with Multi Global Graph System for Advocates, Viewers with Advocate and Viewer graph Acquisition and Lookup Services 280 utilizes the core logic functions to determine the relationship between the desire and needs graph. This global relationship graph provides products, services and persons that are related to opportunities for commerce as well as for tracking and trending. The advocate holds a needs graph of the viewer and the viewer a desire graph which is populated by viewer actions and input.

The relationship graph provides the connection both by delivering to the core logic engine the associated person, place or thing of the desire of the viewer and provides the core logic engine with the profile of eWom opportunities and programmable input for algorithms for the information retrieval and extraction system.

The totality of the information retrieved and extracted provides the basis for the trust and expertise rankings and ratings. The trust rating is a result of input from marketing media viewers and particularly eWom viewers. The expertise ranking and rating is derived from analysis and indexing of the eWag eWom Content Platform 270 and performance criteria extrapolated from the interaction of the viewer of devices, recordable actionable events, messaging and other services such as searching.

Devices drive the discovery engine which provides platform and unique identification data to determine the Viewers identity including use of KeyID.

The actions of the viewer and predetermined actionable events provide the system with parameters to determine the level of performance of advocates. Messaging services provides stochastic information such as discussion about a purchase to determine eWom performance or viral campaign results and populate the relational global graph system.

The subsequent stochastic process or state is determined both by the processes of predictable actions and by a random element such as a text. For an example process such as looking at a car promotion may involve many aspects of decision making. If we take this example and apply to eWom performance we look at the data flow from the Viewer activity using a stochastic kernel (mapping) analyzer and determine statistically, stochastically, through a kernel estimate the conditional or estimated kernel density or options for this decision. So instead of dealing with only one possible way the process might develop over time (as in the case, for example, of solutions of an ordinary differential equation for the same situation), a stochastic or random process takes into account that there is some indeterminacy described by probability distributions (describes the probability of a random variable taking certain courses). These probability distributions then become part of the eWom or marketing media RLSI component used by the core logic engine to determine the probable actions with scoring. These probabilities are defined and placed into the relational global graph system, trust and ranking system as well as E-Procurement user accounts to determine and compare whether the Viewer has purchased or acted on the eWom or marketing media virtualization.

In a preferred embodiment of the present invention, the E-Procurement user is the advertiser, publisher, ad network, agency or purchaser of advocate services.

In a further embodiment of the present invention, the graph protection protocol utilizes Sybilguard. This process utilizes a random walk process based on graph algorithms with all nodes performing random routes along all directions. This walking finds end points for all routes and exposes multiple accounts within the same route with high accuracy which allows the Information Core Logic engine through the Retrieval and Extraction Engine to expose potential Sybil activity or multiple accounts with the same owner within the same source graph. Multiple graph or aggregated graphs create a unique ID for each new import to identify user or owner core accounts. Exemplary algorithms used to create the graphs files for the core logic engine and processing and Sybilguard review are below:

```
          # Topological Sort
# Input records
[node_id, prerequisite_ids]
# Output records
[node_id, prerequisite_ids, dependent_ids]
class BuildDependentsJob {
map(node, prerequisite_ids) {
  for each prerequisite_id in prerequisite_ids {
  emit(prerequisite_id, node)
  }
}
reduce(node, dependent_ids) {
  emit(node, [node, prerequisite_ids, dependent_ids])
}
}
class BuildReadyToRunJob {
map(node, node) {
  if ! done?(node) and node.prerequisite_ids.empty? {
  result_set.append(node)
  done(node)
  for each dependent_id in dependent_ids {
    emit(dependent_id, node)
  }
  }
}
reduce(node, done_prerequsite_ids) {
  remove_prerequisites(node, done_prerequsite_ids)
}
}
# Topological Sort main program
main( ) {
JobClient.submit(BuildDependentsJob.new)
Result result = [ ]
result_size_before_job = 0
result_size_after_job = 1
while (result_size_before_job < result_size_after_job) {
  result_size_before_job = result.size
  JobClient.submit(BuildReadyToRunJob.new)
  result_size_after_job = result.size
}
return result
}
```

A spanning tree is a graph and sub graph that connects all the edges and nodes together. It can assess weight of each edge and assign a weight to a graph (spanning tree) by computing the sum of the weights of the edges in that graph. A minimum graph or minimum weight of the graph is then a graph tree with weight less than or equal to the weight of every other graph in the vertex. An exemplary algorithm is as follows:

```
# Minimum Spanning Tree (MST)
Adjacency Matrix, W[i][j] represents weights
W[i][j] = infinity if node i, j is disconnected
MST has nodes in array N = [ ] and arcs A = [ ]
E[i] = minimum weighted edge connecting to the skeleton
D[i] = weight of E[i]
Initially, pick a random node r into N[ ]
N = [r] and A = [ ]
D[r] = 0; D[i] = W[i][r];
Repeat until N[ ] contains all nodes
Pick node k outside N[ ] where D[k] is minimum
Add node k to N; Add E[k] to A
for all node p connected to node k
  if W[p][k] < D[p]
  D[p] = W[p][k]
  E[p] = k
  end
end
end
```

A preferred embodiment of the present invention is designed with MapReduce and the following Single Shortest Path Algorithm. The shortest single path is finding a path between two vertices (or nodes) in a graph such that the sum of the weights of its edges is minimized.

```
          # Single Source Shortest Path (SSSP)
Adjacency Matrix, W[i][j] represents weights of arc
  connecting node i to node j
W[i][j] = infinity if node i, j is disconnected
SSSP has nodes in array N = [ ]
L[i] = Length of minimum path so far from the source node
Path[i] = Identified shortest path from source to i
Initially, put the source node s into N[ ]
N = [s]
L[s] = 0; L[i] = W[s][i];
Path[i] = arc[s][i] for all nodes directly connected
from source.
Repeat until N[ ] contains all nodes
Pick node k outside N[ ] where L[k] is minimum
Add node k to N;
for all node p connected from node k {
  if L[k] + W[k][p] < L[p] {
  L[p] = L[k] + W[k][p]
  Path[p] = Path[k].append(Arc[k][p])
  }
}
end repeat
# Here is the map/reduce pseudo code would look like
class FindMinimumJob
map(node_id, path_length) {
  if not N.contains(node_id) {
  emit(1, [path_length, node_id])
  }
}
reduce(k, v) {
  min_node, min_length = minimum(v)
  for each node in min_node.connected_nodes {
  emit(node, min_node)
  }
}
}
class UpdateMinPathJob {
map(node, min_node) {
  if L[min_node] + W[min_node][node] < L[node] {
  update L[node] = L[min_node] + W[min_node][node]
    Path[node] =
    Path[min_node].append(arc(min_node, node))
  }
}
}
# Single Source Shortest Path main program
main( ) {
init( )
while (not N.contains(V)) {
  JobClient.submit(FindMinimumJob.new)
  JobClient.submit(UpdateMinPathJob.new)
  }
  return Path
}
```

The single shortest path and also be addressed using breath-first search of first-in first-out (FIFO).

```
# Breadth-first search (BFS)
Adjacency Matrix, W[i][j] represents weights of arc
connecting node i to node j
W[i][j] = infinity if node i, j is disconnected
Frontier nodes in array F
L[i] = Length of minimum path so far from the source node
Path[i] = Identified shortest path from source to i
Initially,
F = [s]
L[s] = 0; L[i] = W[s][i];
Path[i] = arc[s][i] for all nodes directly connected
from source.
# input is all nodes in the frontier F
# output is frontier of next round FF
class GrowFrontierJob {
map(node) {
  for each to_node in node.connected_nodes {
  emit(to_node, [node, L[node] + W[node][to_node]])
  }
}
reduce(node, from_list) {
  for each from in from_list {
  from_node = from[0]
  length_via_from_node = from[1]
  if (length_via_from_node < L[node] {
    L[node] = length_via_from_node
    Path[node] =
    Path[from_node].append(arc(from_node, node))
    FF.add(node)
  }
  }
}
}
# Single Source Shortest Path BFS main program
main( ) {
init( )
while (F is non-empty) {
  JobClient.set_input(F)
  JobClient.submit(FindMinimumJob.new)
  copy FF to F
  clear FF
}
return Path
}
```

The totality of the core logic engine provides a unique method to manage, create, and optimize advocate, viewer and e-procurement based processes and marketing. Those skilled in the art of topical indexing, database management, programmable algorithms processes and information retrieval and extraction will understand the components of this core logic engine can operate within almost unlimited types of structure and architecture.

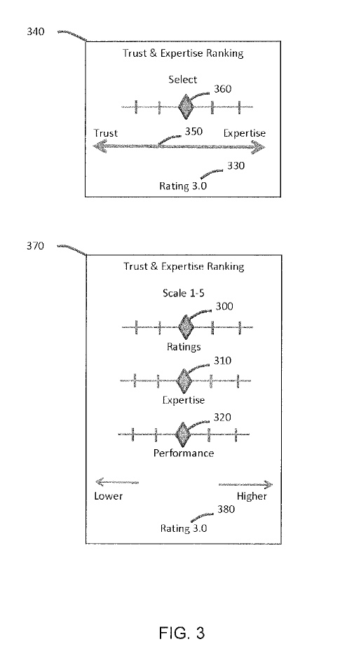

Referring to FIG. 3, a generalized diagram of the Online Trust and Expertise Ranking settings of the invention in accordance with various embodiments described herein is illustrated.

A Trust and Expertise Ranking settings provide information about the user ratings 300, expertise ranking 310 and performance 320 with metrics of the success of the advocates campaigns and services. The rating can be in any form, including numbers. In this example the rating is “3.0” 330. The top interface provides for a selection of ratings based on Trust 340 or Expertise 350 dependent on where the user selects to have the setting diamond 360. The multiple input settings provides the E-Procurement user with a multiple setting approaches to allow selection level importance for each factor for ratings output 300, expertise ranking 310 and performance metrics 320 which will affect the rating. These factors also can be used to select desired types and levels of advocates and advocate groups through the Buy-Sell Auction Platform.

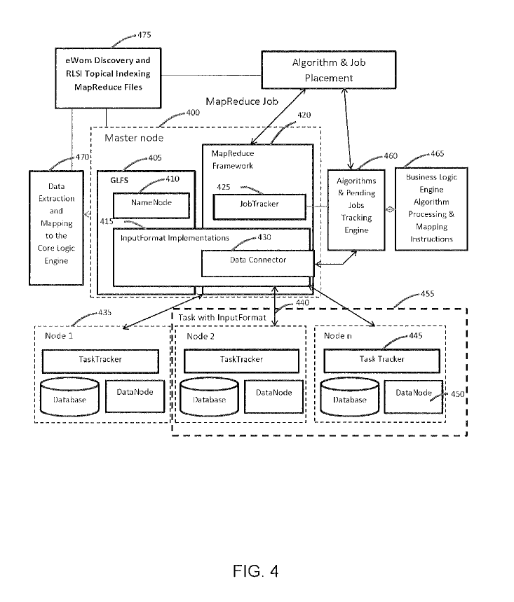

Referring to FIG. 4, a generalized overview of the Information Retrieval and Extraction with eWom Media Discovery and Indexing through RLSI of the invention in accordance with various embodiments described herein is illustrated. This system is designed to maximize the quality of information delivered to the core logic engine through intelligent algorithm evolution and automated schema evolution using polymorphism. It also designed to utilize regularized latent semantic indexing to populate the topical indexing platform for identifying and indexing eWoms, posts, opinions, publishers and other marketing media virtualization within the eWag eWom content management platform and KeyID.

The solution is flexible and dynamic with real time impact on all aspects of this invention. The algorithms optimize effectiveness of the system and use processes to track non-malicious as well as malicious activities. The data cleaning and mapping component provides extraction to the core logic engine. The data structure is formatted based on the core logic engine parameters and polymorphism for operating efficiencies.

The current embodiment utilized a Hadoop MapReduce structure. The framework supports data-intensive distributed applications, which enables applications to work with thousands of computational independent computers and petabytes of data. Hadoop was derived from Google's MapReduce and Google File System (GFS).

The Master Node or Hadoop Distributed File System (HDFS) 400 provides a data replicating system to assure integrity in the event of a fault in any components. The system envisioned utilizes multiple Master Nodes 400 across with multiple worker Nodes 435. A slave or Worker Node 435 acts as both a DataNode 450 and TaskTracker 445, though it is possible to have Data-only Worker Nodes, and Compute-only Worker Nodes for retrieval only tasks. The HDFS 400 is managed through a dedicated NameNode 410 server to host the filesystem index, and a secondary NameNode that can generate snapshots of the namenode's memory structures, thus preventing filesystem corruption and reducing loss of data. The standalone JobTracker server 425 can manage job scheduling.

HDFS 400 is a distributed, scalable, and portable filesystem written in Java for the Hadoop framework. Each node in a Hadoop instance typically has a single Datanode 435; a cluster of Datanodes 455 form the HDFS cluster.

Each Datanode 435 serves up blocks of data over the network using a block protocol specific to HDFS. The filesystem uses the TCP/IP layer for communication; clients use remote procedure calls (RPC) to communicate between each other. Data nodes can communicate to each other to rebalance data, to move copies around, and to keep the replication of data high.

The Secondary Namenode regularly connects with the Primary Namenode and builds snapshots of the Primary Namenode's directory information, which is then saved to local/remote directories. These checkpointed images can be used to restart a failed Primary Namenode without having to replay the entire journal of filesystem actions and edit the log to create an up-to-date directory structure.

The Jobtracker 425 schedules map/reduce jobs to Tasktrackers 445 with an awareness of the data location.

File access can be achieved through the native Java API, the Thrift API to generate a client in the language of the users' choosing (C++, Java, Python, PHP, Ruby, Erlang, Perl, Haskell, C#, Cocoa, Smalltalk, and OCaml), the command-line interface, or browsed through the HDFS-UI webapp over HTTP. The system integrates an Algorithm Scheduler 455 with the JobTracker 425 and TaskTracker 445 and sync with the Core Logic Engine to adjust the Mapping 465 based on the protocol defined. Data Extraction and Mapping 470 to the Core Logic Engine is also defined by the results of the Algorithm including analysis of Pending Jobs Database 460 as defined by the Core Logic Engine.

For the Regularized Latent Semantic Indexing, the Map and Reduce operations are executed in a distributed computing algorithm which updates U, V, P and A variables using the MapReduce operations as outlined in FIG. 2 and eWom Discovery and RLSI Topical Indexing MapReduce Files 475 extraction to the eWag eWom Marketing Media Database with Content Management Platform.

The Information Extraction and Retrieval System provides crawling-spidering, scraping-parsing, web-bots, streaming, multi-media and all forms of information extraction and retrieval including extraction and retrieval of messaging platforms, news feeds, search engines, eWom corpus, posting and review sites, and all site or systems for virtualization of marketing media by the system determined by the requirements of the instructions from the Core Logic Engine.

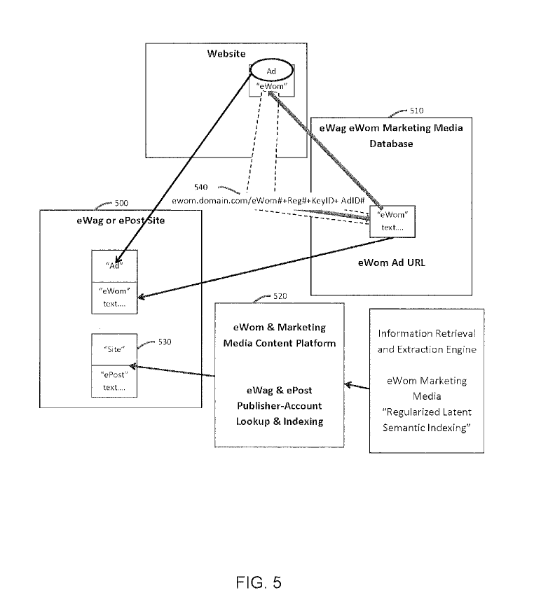

FIG. 5 illustrates a generalized diagram of the eWag eWom Marketing Media Database with Content Management Platform of the invention in accordance with various embodiments described herein. The eWag or ePost sites 500 provide both the indexing and webpages for display of regularized latent semantic indexed content. It utilizes the core logic engine processes and Ajax framework for building dynamic web pages on the client side. Data is read from and sent to the server by JavaScript requests.

The system is built on a dynamic system utilizing the core logic engine and information extraction and retrieval systems. The social world changes fast and the indexing and Uniform Resource Identifier (URI) and Uniform Resource locator (URL) format of this invention can change in real time. The need for an intelligent system takes into consideration not only semantic indexing but also schematic requirements.

The eWag eWom Marketing Media database 510 represents the recording and lookup databases for indexing and management of Advocate eWom Marketing Media. The core logic engine provides the definitions for indexing information and recording results within the correct Advocate database.

An ePost site 500 is used to hold eWom Marketing Media RLSI results for eWag eWom Content Management that are not identified with an Advocate or Viewer. The ePost site can pull this content into an Advocate site when the Advocate places the eWag site URL or KeyID into a post of that account. The KeyID is a part of the Advocate or Viewers Account ID process. It also provides a mechanism for tracking campaigns. The KeyID provides a method to aggregate all accounts into one eWag account and populate for increasing levels of expertise for the Trust and Expertise Ranking.

The eWag eWom Marketing Media database 510 utilizes URI locator processes to index extracted and retrieval information and link to a URL.

There are two forms of eWom content pages: ePost which is a single post account; eWag which is multiple post accounts within one group. Either can be recorded in both formats with the same ePost/eWag. An exemplary URI form is as follows:

ePost: or eWag: request is a request for translation into a URL or can be provided as a KeyID

ePost ID System: ePost: [ID]/site/; ePost: [ID]/site/account/; ePost: [ID]/site/account/publisher/

Publisher is the Account Name in this embodiment. Account is the email address in this embodiment.

eWag ID System: eWag: [ID]/site/; eWag: [ID]/site/account/; eWag: [ID]/site/account/publisher/

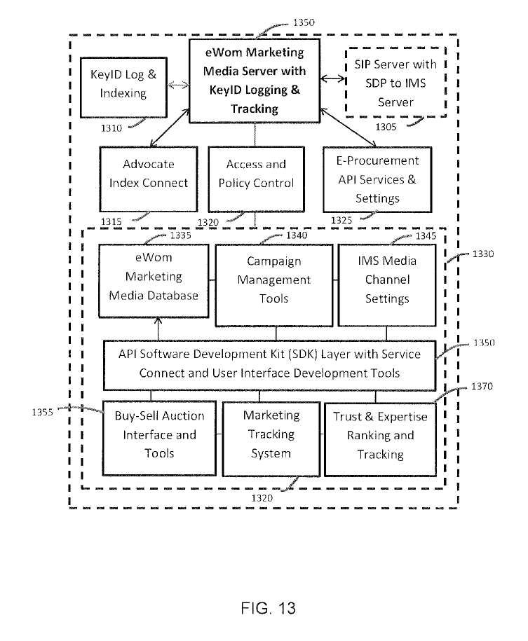

The eWom & Marketing Media Content Platform 520 creates the eWag or ePost Domain or URL from the indexed URI for the display of the ePost or eWag content 530 on the eWag through the eWom Content Management Platform. The eWom account and the Information Retrieval & Extraction Engine through RLSI and eWom Crawling updates the eWom listing with automated updates from eWom Marketing Media Virtualization processes. Within the eWag eWom Content Management Platform are Ad URL's 540 [ewom.domain.com/eWom#+Reg#+KeyID+AdID#] which are also populated to the eWom Marketing Media Server FIG. 13 for Virtualization of eWom's onto Marketing Media: “AdID” comes from the E-Procurement Registration Process with # when the Ad is placed in the eWom Marketing Media server for Virtualization; eWom# is the Advocates eWom choice or custom eWom; Reg# is the Registration Number when the Advocate Registered the eWom Marketing Media; and the KeyID is the Media Marketing Tacking ID used to track processes and identify actionable events as well viral and marketing campaigns.

A Tracking KeyID is integrated into each ePost and eWag ID. It is appended to the each URI and URL for eWom Virtualization. This unique KeyID is tracked through the Advocate Marketing System from Creation and Registration, to Publishing and Delivery. The Unique Tracking KeyID is pulled from each Advocate and Viewer Account ID.

The system can use a plurality of database configurations including mapping system for information extraction and retrieval system MapReduce Framework and Core Logic Engine services.

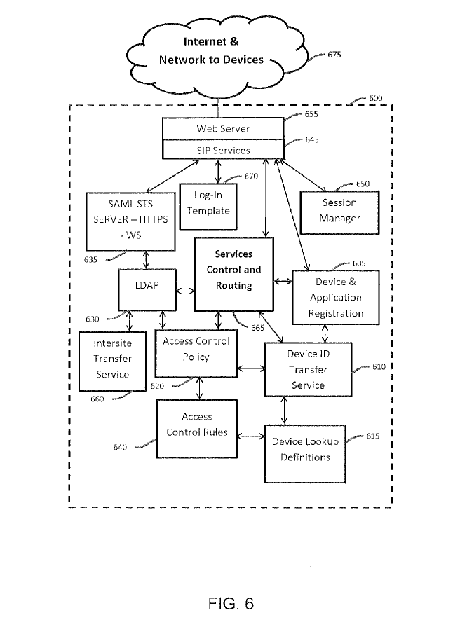

FIG. 6 illustrates a generalized description of an Authentication, Authorization and Device Registration Gateway of the invention in accordance with various embodiments described herein.

The Authentication, Authorization and Device Registration Gateway provides a block of services associated with Viewer ID, Temp Viewer ID, Advocate ID and E-procurement ID. A Single sign-on flow traditionally used for web browsers is enabled in desktop and mobile apps. Authentication is also designed to provide delegated authentication. In this embodiment PersistentGlobalCookies, Javascript API's, and Persistent Security Assertion Markup Language (SAML) ID & Tokens are used for Viewer ID.

SAML supports secure interchange of authentication and authorization information by leveraging the core Web services standards such as XML, Simple Object Access Protocol (SOAP), and Transport Layer Security (TLS) as well as Single Sign-On technology. Session Initiation Protocol (SIP) is also as a signaling service for IP Multimedia Subsystems (IMS) which is a standardized Next Generation Networking (NGN) architecture for mobile and fixed multimedia services.

Utilizing a Single Sign-On authorization request to or from the external service providers such as social, membership and service platforms and using an embedded browser the client asks for authorization from the user to a managed URL; the authorization server detects the user request to authenticate and redirects to SAML Lightweight Directory Access Protocol (LDAP); the URL for authorization is passed via a RelayState parameter; user accesses their IDP and authenticates; authentication is performed by the IDP; when authenticated the IDP sends a SAML Response though the Client browser with RelayState to the OAuth authorization or STS server; the SAML assertion is accepted and logs the user in; the digital signature applied to the SAML Response allows verification that the message is from a Client system at which points the user is authenticated and redirected to the SpringSource Tool Suite (STS) server; the user authorizes the application; once authenticated the user is prompted to approve the application connecting; the application is issued a customized OAuth token; the application is issued a high-entropy token that can be used to establish a session for the user by the application; subsequent usage of the application does not require the user re-enter their credentials.

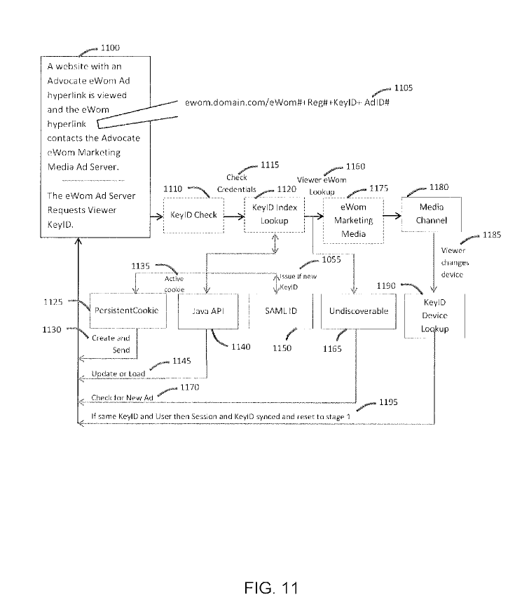

A simple outline of a SAML system is as follows: a user can login at one site; a SAML assertion transfers the user authentication token; and the transferred token provides authentication to a remote site. A SAML package can include the authentication token as well as user attributes that can be tested against the rules engine for authorization and access control. This provides the backbone for the Social/Membership/Services Site API connectivity as well as the services developed by the API Developers and Service Providers. It also provides the ability for Single Sign-On integration for new E-Procurement users and Viewers and an authentication parameter for the Device Discovery processes (shown in FIG. 11) including use of KeyID.

Using SOAP instead of HTTPS offers secure authentication for, inter alia, the eWom Marketing Media Registration System. This embodiment uses an LDAP 630 server for identity and the STS SAML-based server 635 for sending security assertions. The SAML token which is customized to use KeyID is used to pass assertions to trusted resources, which then approve or deny access to data resources. The service uses a rules engine to evaluate authorization rules based on security policies that specify conditions for approval or denial of access to data resources through Access Control Policy 620 and Access Control Rules 640. The rules engine is central to reinforcing policy management.

The Device Lookup Definitions 615 provides a global account for users to move from device to device and maintain login profiles when logged into accounts from other devices in proximity to the originating device. The Device Lookup Definitions 615 is controlled through Access Control Rules 640, Access Control Policy 620 and LDAP 630.

The Device ID Transfer Service sends the a new Device ID utilized by a User to the User, Device Discovery Gateway (shown in FIG. 11) to provide authentication processes for the Advocate and Viewer Marketing System.

Using LDAP as the authoritative source also supports a centralized source for identity management. Rather than managing resource access at the individual resources, user access lists can be managed by using the LDAP and the appropriate policies and the KeyID index in FIG. 13 that define user roles and corresponding data parameters, such as API access and device discovery processes.

The process is simple. The user wishes to access services or the Advocate or E-Procurement systems. They use SOAP Services to login with a username and password pair. The client passes the pair to LDAP 630 for authentication. LDAP 630 validates the user and returns the information to the client; SOAP Services passes the returned LDAP 630 information and other user information to the SAML client 635, which is a service that packages the information in the correct format as a SAML token; SAML client returns the token to the SOAP Services. The SOAP Services wraps the SAML token (STS Server) 635 and the user request into a SOAP request; SOAP Services starts a timed SAML session 635 and sends the SOAP request to the appropriate Web service 620 to fulfill the user requirement. The Web service parses the SAML token and verifies the authentication information via LDAP 630 (the user only logs in once as each Web service can serve as a user surrogate and is trusted by the data resource because the Web service verifies request information); after authentication the Web service sends a request to the SAML server that's running the rules engine 640. The rules engine 640 evaluates user parameters and determines the level of access that the user is authorized. The evaluation is based on a set of rules that reflect predefined access policies. Verification of access level is returned to the Web service; Web service requests data from the data resource packages of the Advocate or E-Procurement user systems 665.

A SAML-based service that uses LDAP 640 as the centralized authority enforces security policies and achieves centralized Identity Provider (IdP) identity management. Group or Delegated Authentication can be created with LDAP 630 and SAML 625 instruction sets. This group structure provides the customer or new API Layer the ability to set approval setting for Viewers. This also allows integration of SIP Services 645 into network management.

Key ID's are: Viewer KeyID; Viewer Temp KeyID; and Advocate KeyID.

A unique KeyID part of the User Account ID is incorporated into the registration process. The KeyID is a unique pseudonym within the Identity Provider (IdP). LDAP 630 is used as the IdP for Viewer Identity. The IdP package can have Metadata as Extensible Markup Language (XML):

Single-Signon Type: SAML 2.0

SAML IdP Entity ID: provide the Entity ID from IdP metadata
XML in entityID attribute of EntityDescriptor Tag.
SAML IdP Metadata including KeyID

### SSO Login URL

### SSO Logout URL

### IdP Metadata XML:

NameIDFormat list. PersistentGlobal NameID supported by emailAddress

SingleSignonService URL and Bindings, HTTP-Post and/or HTTP-Redirect.

SingleLogoutServer URL and Bindings, HTTP-Post and/or HTTP-Redirect Bindings supported.

This initial PersistentGlobal SAML IdP provides Viewer or Advocate ID in association with KeyID. As well a subsequent Java API provides secondary Identity Assertion.

When Registered Advocates or Viewers send a Hyperlink “Invited” processes through Authentication & Authorization Device & Application

Registration 605, the system activates an automated process to upload a PersistentGlobal Cookie or similar Unique PersistentGlobal Java Device Identifier. A PersistentGlobal Java Cookie is loaded into the device utilizing a Javascript API such as:

<script type=“text/javascript” src=“jquery-1.4.2.min.js”></script>
<script type=“text/javascript” src=“swfobject-2.2.min.js”></script>
[<script type=“text/javascript” src=“evercookie.js”></script>
updated code to handle security and application issues]
<script type=“text/javascript” src=“PersistentGlobalCookie.js”></script>
<script>
var ec = new PersistentGlobalCookie( );
// set a cookie “id” to “12345”
// usage: ec.set(key, value)
ec.set(“id”, “12345”);
// retrieve a cookie called “id” (simply)
ec.get(“id”, function(value) { alert(“Cookie value is ” + value) });
// or use a more advanced callback function for getting our cookie
// the cookie value is the first param
// an object containing the different storage methods
// and returned cookie values is the second parameter
function getCookie(best_candidate, all_candidates)
{
alert(“The retrieved cookie is: ” + best_candidate + “\n” +
“You can see what each storage mechanism returned ” +
“by looping through the all_candidates object.”);
for (var item in all_candidates)
document.write(“Storage mechanism ” + item +
“ returned: ” + all_candidates[item] + “<br>”);
}
ec.get(“id”, getCookie);
// we look for “candidates” based off the number of “cookies” that
// come back matching since it's possible for mismatching cookies.
// the best candidate is most likely the correct one
</script>

This identifies the client with a unique Device or Viewer KeyID which can be created based on Subscriber Identity or Electronic Serial Number (ESN) or other electronic ID or similar Electronic ID. Combined with a destination IP address the system identifies the Viewer or Advocate and combined with registered Social, Membership and Service accounts a Global Device Identity System.

Both processes utilize a list of advertising and marketing, network, and domain cookies providers for IP lookup and activation of Java API, to activate the Viewer or Advocate Lookup process through the Authentication and Authorization system and SIP Server.

The LDAP 630 is updated from the Device ID Transfer Service 610 to the access control policy 620 controller. The Intersite Transfer Service 660 searches for other similar ID's that may be within Advocates networks. This ID or KeyID then provides information for the SIP and IMS services during Device Discovery and Virtualization of digital marketing media and eWoms including searches for similar ID's within the Advocates Viewer Network Database 1005. If the system issues a Temp KeyID it updates the Advocate Viewer Network Database as well updates the Viewer Network to KeyID from Temp KeyID.

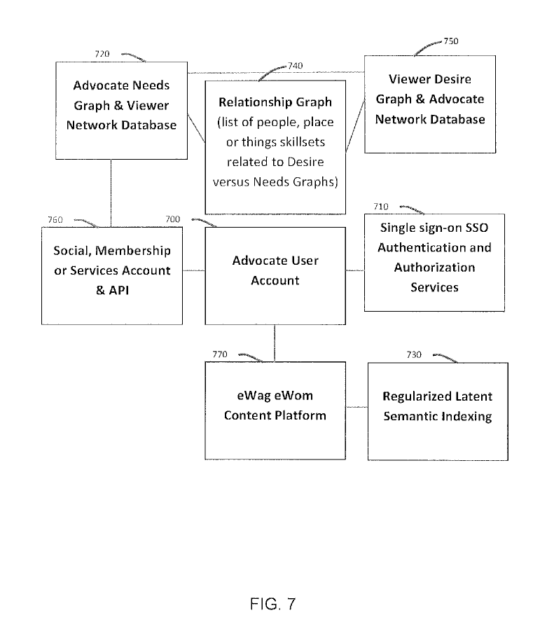

FIG. 7 illustrates a generalized description of Advocate and Viewer Accounts, with Multi Global Graph and Network Acquisition, and Relationship system of the invention in accordance with various embodiments described herein.

The Advocate and Viewer account platform provides the initial point of acquisition for identifying the Advocates network and Viewers. The Advocates populate the Advocate Viewer Network database and the system provides options to acquire the Viewers listed and additional acquisition service options.

Several processes are used to identify the Viewers including hyperlinks from the Advocate to the Viewer which registers the Viewer and social, membership or service account when the link was activated. The system populates the device with a PersistentGlobal cookie, Java API and other identification processes to initiate the new customer or Advocate acquisition processes. The hyperlink can activate through a pop-up dialog, website, instant messaging, or any platform the Advocate wishes to use to initiate the Viewer.

Advocates have a Viewer Network. When an Advocate account is created, a Viewer Network Account and Services is created and activated and Social, Membership, and Services Account Graph Import API's.

Viewers have an Advocate Network. When the Viewer clicks on a hyperlink, a Viewer Account and Services is created and activated. An Advocate Network database is populated and linking analysis starts to finds existing Advocates with Viewers profile to add to the Viewers Advocate Network.

A user account 700 is created connected through the authorization and authentication system 710 and provides credential processes to validate services through shared SSO (single-sign-on) authentication and authorization keys within the authorization and authentication system. A PHP Java API provides the repository to the advocates network database 720. The network account 720 is defined as known users and contacts that the advocate may have some influence. The system further defines possible expertise utilizing regularized latent semantic topical indexing 730 with publisher keys and performance metrics defined by the advertiser, ad network, publisher, agency or marketing media supplier.

A unique KeyID part of the User Account ID is incorporated into the registration process. The KeyID is a unique pseudonym within the IdP or Identity Provider.

NameIDFormat list. PersistentGlobal NameID supported by emailAddress

SingleSignonService URL and Bindings, HTTP-Post and/or HTTP-Redirect.
SingleLogoutServer URL and Bindings, HTTP-Post and/or HTTP-Redirect Bindings supported

This initial PersistentGlobal SAML IdP provides Viewer or Advocate Lookup in association with KeyID. As well a PersistentGlobalCookie Java API provides secondary Identity Assertion.

In this embodiment a traditional invitation process is used. Registered Users or Viewers Hyperlink “Invited” processes through Authentication & Authorization Device & Application Registration 605 the system activates an Automated process to upload an PersistentGlobal Cookie or similar Unique PersistentGlobal Java Device Identifier. A PersistentGlobal Java Cookie is loaded into the device utilizing the Javascript API.

This identifies the client with a unique Device or Viewer KeyID which can be created based on Subscriber Identity or Electronic Serial Number (ESN) or other electronic ID or similar Electronic ID. Combined with a destination Internet Protocol (IP) address the system identifies the Viewer or Advocate and combined with registered Social, Membership and Service accounts a Global Device Identity System.

Both processes utilize a list of advertising and marketing network cookies and domains and marketing media providers for IP lookup and activation of Java API, to activate the Viewer or Advocate Lookup process through the Authentication and Authorization system and SIP Server.

A user account 700 data schema based on needs and desire is created with a global relational graph 740 linked profile. The relational linked profile 740 delivers the properties that may be associated with expertise in areas the viewer may find appealing based on the person, place or thing being advocated as well incorporates stochastic processes and states from the core logic engine FIG. 2. This stochastic information, such as discussion about a purchase to determine eWom performance or viral campaign results, populates the relational global graph system.

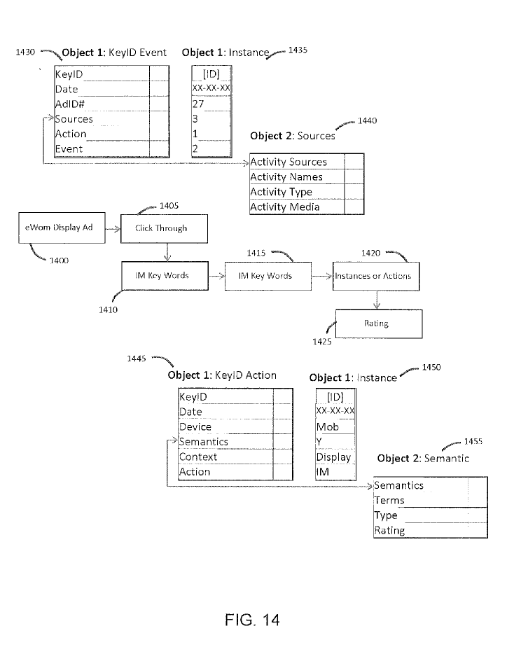

The subsequent stochastic process or state is determined both by the processes of predictable actions and by a random element such as a text. The information retrieval and extraction engine combined with the RLSI extracts Key Words (shown in FIG. 14) associated with Viewer actions to find actionable events not measurable with the current model. So instead of dealing with only one possible measure, this process provides a Key Word (see FIG. 14) based model to confirm purchases outside of the traditional online metrics. All these stochastic related processes and data assist in identifying the characteristics and indexing for the global relational graph system.

The relational global graph 740 links individuals, entities, products and services to the Viewers interest or desire graph 750 input and enables automated identification of opportunities.

For each advocate the system provides an acquisition API 760 through a format similar to Friend of a Friend (FOAF) that allows the advocate to populate the advocate network from a social, membership or service accounts with base information.

<foaf:Person>
<foaf:name>name</foaf:name>
<foaf:gender>gender</foaf:gender>
<foaf:title>title</foaf:title>
<foaf:givenname>given</foaf:givenname>
<foaf:family_name>family</foaf:family_name>
<foaf:nick >nick</foaf:nick>
<foaf:mbox_sha1sum>...(inverse functional property)...
</foaf:mbox_sha1sum>
<foaf:homepage rdf:resource=“http://www.domain.com”/>
<foaf:weblog rdf:resource=“http://www.domain.com/blog/”/>
<foaf:workplacehomepage rdf:resource=“http://domian.com/” />
<foaf:depiction
rdf:resource=“http://givenfamily/images/pic.jpg” />
<foaf:knows>
<foaf:Person>
<foaf:name>name</foaf:name>
</foaf:Person>
</foaf:knows>
</foaf:Person>

The advocate API (Application Programming Interface) PHP and Java extraction program pulls the base information plus semantic to populate the Advocate Global Graph 720 schema based on the Core Logic Engine definition.

The Core Logic Engine defines the Advocates expertise utilizing the eWom, blog, opinion and other digital postings populated into an eWag eWom content pages 770. This process combine with core logic engine stochastic to evaluate potential links between Viewers desires and Advocates expertise and creates the global relational graph indexing.

The car relational graph would be populated with terms such as: mechanic, vehicle sales, auto paint, window repair and many more aspects and terms without the impairment of mismatched semantic terms utilizing the processes of this invention and link to needs processes for the advocate expertise lookup.

The system further searches within the buy-sell auction platform for potential matches from advertisers, ad networks, publishers, agencies and suppliers for monetization of eWom Marketing Media and digital marketing services.

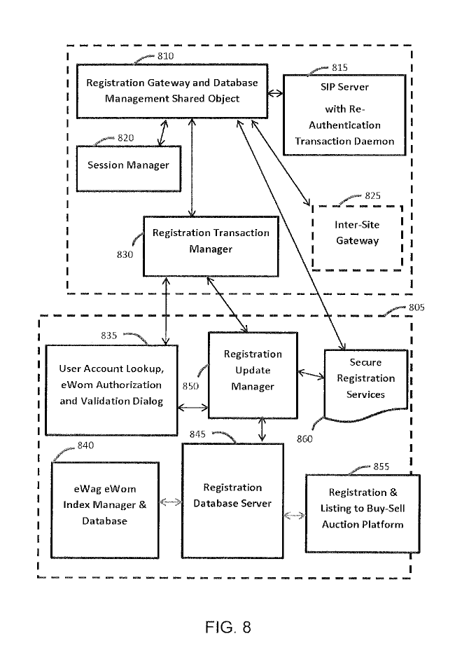

FIG. 8 illustrates a generalized description of a Digital Rights Registration System with eWom Marketing Media Indexing to eWag of the invention in accordance with various embodiments described herein.

The eWom Marketing Media utilize Digital Rights Registration to identify ownership of digital properties and marketing rights. eWag and eWom URI's and URL's are incorporated into the indexing of the eWom address or eWag eWom [ewom.domain.com/eWom#+Reg#+KeyID+AdID#]. Within the eWag eWom is the Registration # as well the Account KeyID. Both are incorporated into the registration processes and link. The AdID is incorporated later with parameters such as media type and routing.

The system uses SOAP (Simple Object Access Protocol) for transferring messages between applications, SIP (session initiation protocol) for session management with SDP (session description protocol), and WSDL (Web Services Description Language) for defining web services and interfaces, and secure SOAP or XML or XML with SSL for protecting the communication in the transactional components of the invention.

This protected environment of the registration system is important as it is used by E-Procurement process to secure the eWom's for publishing through the User Account Lookup, eWom Authorization and Validation Dialog. The system confirms the User Account is active, the eWom is authorized by the E-Procurement eWom Marketing Media Ad provider, and validates the registration.

Until now there were no tools to exploit the opportunity to monetize eWom Marketing Media. A Digital Rights Registration Gateway and Database Management Shared Object with stored procedures and operating functions 810 provides the gateway for all systems to lookup, register and validate an authorized and active eWom Marketing Media registration. As well, an inter-site gateway 825 monitors states, authentication, authorization and processes throughout the system.

The following is a generalized example of the transaction manager and how it coordinates all the processes to satisfy a registration process and part of the process of the E-Procurement buyer listing requests for eWom Marketing Media on the Buy-Sell Auction Platform 835

In one embodiment, the E-Procurement provider, CuiInitial, has set up a session with the SIP server 815, has been transferred using the inter-site transfer service to the Registration Gateway and Database Management Shared Object 810, and the Session Manager 820 to the Registration Transaction Manager 830 has assigned a Session ID.

CuiInitial gets the session ID from the SIP server 815, it invokes the createTX( ) method in TXManager (Registration Transaction Manager 830) to create a new transaction; CuiInitial gets a unique transaction ID from TXManager 830; CuiInitial can now invite transaction participants and it send a message to the Registration Database Server 845 to join the transaction; the Registration Database Server 845 then joins in the transaction by invoking TXManager joinTX( ) method; TXManager 830 returns the joining result to the Registration Database Server with confirming information; the Registration Database Server gets the confirmation result from TXManager 830 and gives CuiInitial an invitation response to indicate that it has joined in the transaction; CuiInitial invites the eWom Provider 835 to join in the transaction; CuiInitial gets all the invitation responses from the Registration Database Server 845 and eWom Provider 835, it tells TXManager 830 to hold the required eWom Marketing Media 840 subject to validation to the Registration Database Server 845 record and that the eWom Provider 835 has accepted the transaction by invoking the commit( ) method in TXManager 830; TXManager 830 then gives the eWom information to the Registration Database Server 845 for registration; the Registration Database Server Update Manager 850 checks the E-Procurement Listing state information, they each give a prepared response to TXManager 830 which declares that they have prepared for the approval 840; once the TXManager 830 receives the prepared responses from both the Registration Database Server Update Manager 850 and eWom Provider system 840, it commits the registration state and then gets the transaction states from SOAP; finally, TXManager 830 sends the approval result to CuiInitial; WebMsgClient returns the checking session result to Session Manager 820 TXManager 830 with a boolean value; the boolean value will be sent from TXManager 830 to SOAPRequestHandler; after receiving a positive result, the listcategory( ) method call will be delivered to TXManager 830; TXManager 830 makes use of TXDBHandler to query the database of the service provider and returns the result; during the procedure of generating a SOAP response to the E-Procurement provider, a SOAPResponseHandler is used to get the Session ID 820 from the TXManager 830 through invoking the setSOAPHeader method of TXManager 830; then the SOAPResponseHandler will add the Session ID 820 into the SOAP header element of the SOAP response message; the SOAP response message is received by TXManager 830; TXManager 830 informs the Registration Database Server 845, and eWom Provider 835 and the registration has been successfully completed.

The registration is now forwarded to the Buy-Sell Auction Platform through the Registration & Listing to Buy-Sell Auction Platform.

It is understood by those skilled in the art of digital registration process that there are many technologies and techniques available for this process and future methods under development. In no way does this embodiment limit the application of registration and approval techniques, process, indexing, and tracking.

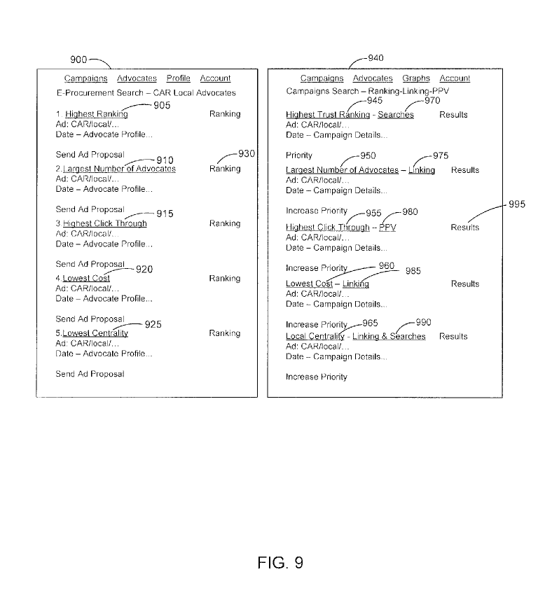

FIG. 9 illustrates a generalized description of a Buy-Sell Auction Platform with E-Procurement of the invention in accordance with various embodiments described herein.

The Advocate and E-Procurement Buy-Sell Auction Platform is an eWom Marketing Media E-Procurement Platform with Ajax framework for building dynamic web pages on the client side. Data is read from and sent to the server by JavaScript requests.

In this embodiment the Advocate has registered eWom Marketing Media through the Digital Right Registration Platform and the eWom Marketing Media has been approved and a URL has been created with a Registration Number [ewom.domain.com/eWom#+Reg#]

The system automatically registers the eWom and analyzes the value based on the Trust and Expertise Ranking of the Advocate. The E-Procurement User has registered and is searching for a group of Advocates for a marketing effort.

In the first search, the Advocate looks for a group of qualified Advocates to market a Car 900. The system displays several results based on differing criteria including: Highest Ranking 905; Largest Number of Advocates 910; Highest Click-Through 915; Lowest Cost 920; and Local Centrality 925 all with accompanying Trust and Expertise Ranking 930.

These query functions are established through the Core Logic Engine. These examples will adjust as new eWom Marketing Media opportunities and criteria are found and incorporated through the Polymorphic Database Schema process.

The next step in this example the E-Procurement User looks for a results based search. The base criteria then displays several fields including method of marketing: Searches 970; Linking 975; PPV; Linking 985; and Linking and Searches 990. All with a link to results 995.

Once the E-Procurement User has selected the Advocates and Criteria and estimated campaign cost and accepted the eWom Marketing Media Registration is appended to an AdID [ewom.domain.com/eWom#+Reg#+AdID]. This URL is then directed to the eWag Marketing Media Server in the API (Application Programming Interface) Platform with Discovery and Routing Services.

The eWom Marketing Media listing can remain Persistent and used for other E-Procurement efforts such as location based marketing using criteria the Advocate inputs combined with Trust and Expertise Ranking that matches the E-Procurement User threshold.

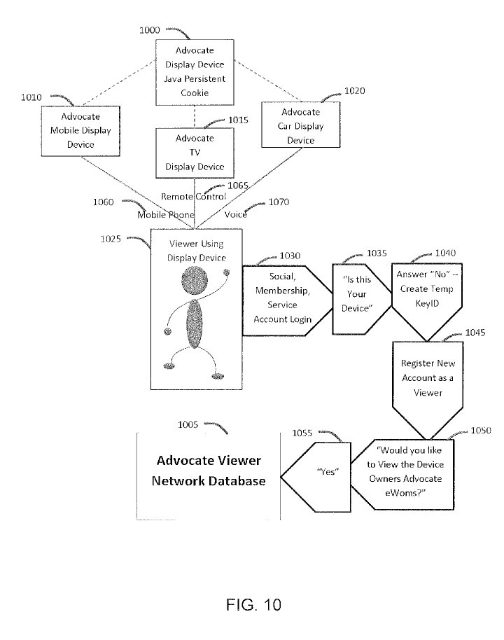

FIG. 10 illustrates a generalized view of Advocate & Viewer eWom Network Accounts, Devices & Applications Auto Population Processes of the invention in accordance with various embodiments described herein.

In this embodiment the Advocate has registered Devices through an automated process within the Authentication and Authorization process of the OAuth SSO process or access to the Advocate Account. The PersistentGlobal Java Cookie authentication process 1000 utilizes a Javascript API that produces extremely PersistentGlobal cookies and Device KeyID. It identifies the client even after they've removed standard cookies and becomes a permanent unique mobile device identifier. If the user removes any of the type of cookies, it can recreate using: standard HTTP cookies; storing cookies in RGB values of auto-generated, force-cached PNGs using HTML5 canvas tag to read pixels (cookies) back out; cookies in web history; cookies in HTTP eTags; cookies in web cache; session storage; local storage; and global storage. It also can use Java to produce a unique key based of the Subscriber Identity, Electronic Serial Number (ESN) or similar electronic ID. Combined with a destination address affinity persistence IP address the system identifies the user or Viewer and Advocate registered social, membership and service accounts.

The Authentication and Authorization LDAP in FIG. 6 is updated with Device ID Transfer Service 610 through the Access Control Policy 620 Controller which initiates the Intersite Transfer Service 660 to record the Device Definitions and search for similar ID's that may be within the Advocates Viewer Network Database 1005 and transfer to the Advocate Viewer Network Database and Update the Viewer Network KeyID. This ID provides information for the SIP and IMS services during Viewer and Device Discovery processes to Virtualize eWoms Marketing Media.

This combination provides automated Javascript PersistentGlobal ID and population to the Advocate Viewer Network Database of the new Viewers Identity creates a profile of the Viewer and preferences.

In this example the Advocate has provided access to a Mobile Device 1010, TV Display Device 1015, and Car Display Device 1020 to a Viewer 1025. Each Display Device has an Advocate Javascript PersistentGlobal API. The Viewer uses a Device Application or Site Login and a dialog asks the Viewer “Is this Your Device” 1035, the Viewer answers “No”—Create Temp KeyID 1040. The dialog then asks ““Would you like to View the Device Owners Advocate eWoms?” 1045, the Answer is “Yes” 1050. The application then registers the Viewer with a Temp KeyID and as a member of the Advocates Network as the Core Logic Engine processes through Index Files, Viewer Graphs, Information Retrieval and Extraction Graph Crawls, and LDAP ID's to match to an existing user otherwise the Temp KeyID is held until the Temp Viewer uses the Display Device again including a unique PersistentGlobal Cookie and PersistentGlobal SSO SAML ID & Token.

This system works with all forms of communication including biometric. In this embodiment the system recognizes that the Viewer is not the Owner based on the logins not being part of the Advocates Account. The Viewer uses a Mobile 1055, Entertainment Control 1060, and Car Display Device 1065 of the Advocate using a Mobile Phone, Remote Control and Voice Input.

As well as multiple users on each Display Device this system provides SSO with multiple devices activated.

FIG. 11 illustrates a generalized description of a User, Device Discovery Gateway with eWom Marketing Media Lookup of the invention in accordance with various embodiments described herein.

The User and Device Discovery Gateway utilizes an indexing system with a Viewer Temp KeyID for multiple users on the same device. A PersistentGlobal Cookie, Java API and SAML ID provides methods for Viewer KeyID lookup within this embodiment but it should be obvious to those experienced in the art of Device Discovery that there are many methods to create and identify the user and incorporate said into the Viewer KeyID indexing system.

The KeyID eWom Advocate Viewer Index is populated real time based on existing Network Viewers and Temp Viewers. The Viewer and Temp Viewer system creates a Viewer Advocate Lookup that is accessed using the KeyID. The KeyID provides the indexing from Advocate to Viewer and Viewer to Advocate and also Tracking ID for the Viral and Marketing Tracking System with Double-Hermeneutics and Semantic Services.

The Viewer Advocate Device Indexing system uses a relational based object database (ORDBMS) which is a database management system (DBMS) similar to a relational database but with an object-oriented database model: objects, classes and inheritance are directly supported in database schemas and in the query language. In addition it supports extension of the data model with custom data-types and methods.

This type of database maps well for query and can be converted to an index and inverted index to optimize system operation.

An example of the eWom Marketing Media Virtualization and Viewer Dicsovery process in this embodiment has the following steps: A website with an Advocate eWom Ad hyperlink ewom.domain.com/eWom#+Reg#+KeyID+AdID# 1105 is viewed and the eWom hyperlink contacts the Advocate eWom Marketing Media Ad Server 1100; the Ad Server Requests Viewer KeyID 1110; System checks KeyID through the PersistentCookie 1135; Java API 1140; and SAML ID 1150; if the PersistentCookie is not present the system sends a message to create and send to the Viewer Device 1130; if the Java API is not present the system sends a message to update or upload 1145; if the SAML Certificate and ID are not present then the STS Server sends a new Certificate which creates a new KeyID 1055. The KeyID Index Lookup 1120 confirmation is complete and the system checks for a Viewer eWom 1160. If the system is unable to find the eWom for the Ad selected the system checks for a New Ad 1170. If the system finds the Ad it is delivered through the designated Media Channel 1180. If the Viewer changes devices the system reactivates the KeyID Device Lookup 1190 and if it is confirmed the same Viewer it activates eWoms based on the original KeyID 1195.

If the Viewer is using a Device that is registered or identified as another Viewer or Advocate a Temp KeyID is created and issued. The Core Logic Engine analyzes Index Files, Viewer Graphs, Information Retrieval and Extraction Graph Crawls, and LDAP ID's to match to an existing Viewer or Advocate and if confirmed syncs the Temp KeyID with the Viewers original KeyID.

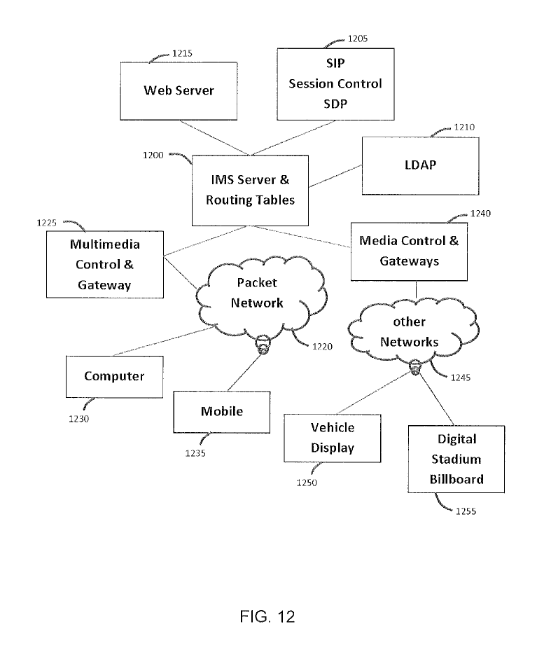

Referring to FIG. 12, a generalized description of a Media Gateway for Delivery and Routing of eWom Marketing Media of the invention in accordance with various embodiments described herein is illustrated.

The delivery channels for the eWom Marketing Media of this embodiment are almost unlimited. They are both physical as well as digital. The physical channels involved marketing media including with Stock Keeping Unit (SKU) and Quick Response (QR) type codes that activate digital channels to Virtualize the eWom Marketing Media.

In this embodiment an IMS 1200 is the architectural framework. The delivery protocol is Internet Protocol (IP) or Transmission Control Protocol/Internet Protocol (TCP/IP). The eWom Marketing Media require an architectural framework that provides a common method for multiple IP networks. Information Technology (IT) and communications are middleware in that an interface sits between the networks and applications and services that provides a common channel and can integrate into an application programming interface (API).

IMS delivers seamless services where customers are able to deliver and access any type of service, from any device they want to use, with single sign-on, with common contacts and fluidity between wired and wireless services with: common user interfaces for any service; open application server architecture to enable a ‘rich’ service set; separate user data from services for cross service access; standardised SIP session control 1205; inherent service mobility; and network independence.

The Session Description Protocol (SDP) 1205 is a format for describing streaming media initialization parameters. The Internet Engineering Task Force (IETF) published the original specification as an IETF Proposed Standard in April 1998,[1] and subsequently published a revised specification as an IETF Proposed Standard as RFC 4566 in July 2006.[2]

SDP is intended for describing multimedia communication sessions for the purposes of session announcement, session invitation, and parameter negotiation. SDP does not deliver media itself but is used for negotiation between end points of media type, format, and all associated properties. The set of properties and parameters are often called a session profile. SDP is designed to be extensible to support new media types and formats.

The described process allows SDP to define the following parameters:

Session description
v=(protocol version)
o=(originator and session identifier)
s=(session name)
i=* (session information)
u=* (URI of description)
e=* (email address)
p=* (phone number)
c=* (connection information—not required if included in all media)
b=* (zero or more bandwidth information lines)
One or more time descriptions (“t=” and “r=” lines; see below)
z=* (time zone adjustments)
k=* (encryption key)
a=* (zero or more session attribute lines)
Zero or more media descriptions
Time description
t=(time the session is active)
r=* (zero or more repeat times)
Media description, if present
m=(media name and transport address)
i=* (media title)
c=* (connection information—optional if included at

a. session level)

b=* (zero or more bandwidth information lines)
k=* (encryption key)

IMS encompasses any services that use IP/Multi-Protocol Label Switching (MPLS)/Generalized Multi-Protocol Label Switching (GMPLS) as transport and most of the fixed and mobile access technologies including ADSL, cable modem DOCSIS, Ethernet, Wi-Fi, WIMAX and CDMA wireless. IMS incorporates all of the currently deployed access technologies. IMS is focused on IPv6. IN this diagram the Multimedia Control and Gateway 1225 for the Packet Network 1220 and the Media Control & Gateways for the MPLS (Multi-Protocol Label Switching) Transport 1245 are routed through the IMS Server 1200. LDAP 1210 is used along with the E-Procurement User KeyID for authentication and authorization of routing channels.

SIP supports five facets of establishing and terminating multimedia communications:

User location: determination of the end system to be used for communication

User availability: determination of the willingness of the called party to engage in communications

User capabilities: determination of the media and media parameters to be used

Session setup: establishment of session parameters

Session management: including modifying session parameters, and invoking services

Although SIP has been primarily used in the past for voice multimedia services the new technologies and media channels currently in use have made this technology and flexibility more important for the worlds NGN or Next Generation Network.

The packet network 1220 handles all TCP/IP based transport to devices such as Mobile 1235 and Computing 1230. The MPLS (Multi-Protocol Label Switching) Transport 1245 handles transport to Display Devices such as in Vehicles 1250 and on Digital Billboards 1255.

Even with this outline it would be understood by those skilled in the art of Multicast, IMS, MPLS, and Next Generation Network systems that there are many technologies and techniques available and future methods under development for delivering marketing media but that the IMS platform provides the systems and protocol along with authentication, authorization and session management for accurate and compliant delivery.

Referring to FIG. 13, a generalized description of an eWom Marketing Media Server with API (Application Programming Interface) Platform with Discovery and Routing Services of the invention in accordance with various embodiments described herein is illustrated.

The eWom Marketing Media and E-Procurement Platform is designed to provide acquisition, creation and delivery of eWom Marketing Media for Campaigns. Further the system provides tracking through KeyID's from source to action and from action to completion of transaction big or small.

The E-Procurement API Platform provides services for definitions, provisioning, and control of the eWom process from beginning to end. The Web Services deliver a Procurement Interface with API services profiles and settings. The API and Layers system is envisioned to provide the most flexible platform for delivering eWom Marketing Media with Automated delivery when the E-Procurement User completes a transaction.

The E-Procurement User has made an offer and completed a transaction on the Buy-Sell Auction Platform for a group of Advocates and the Advocates have accepted. The E-Procurement User now has a series of Advocate eWoms Marketing Media eWag eWoms that only require definition of the E-Procurement channels the E-Procurement User requests. The original eWom URL is as below.

ewom.domain.com/eWom#+Reg#+KeyID+AdID

When the E-Procurement User activates the eWom the system appends a unique number to the end of the AdID. This AdID is created when the E-Procurement User created their account. The number designates a specific Advocate and a Specific Campaign. It now has the number as below:

ewom.domain.com/eWom#+Reg#+KeyID+Ad ID#

The eWom is now ready to go.

The system now places the eWom into the eWom Ad Server. The eWom Marketing Media & API Server is now populated with the eWom for delivery. The system has an Advocate Index Connect maintained as an indexed version of the Advocate and Viewer Networks for that specific AdID# which can be optimized by converting into an Inverted Index.

The API or application programming interface provides the back-end for E-Procurement Users to create new services, applications and markets using the plurality of services that can be envisioned by business and entrepreneurs.

The API platform can be viewed as an extension of the eWom Marketing Media world with the network the community you build, not the systems you use. The invention is built with a model that can work within any environment and protocol. Utilize the reach of the internet and maximize future services Advocates. This example embodiment is built on the SOAP (Simple Object Access Protocol), SIP (session initiation protocol), SDP (session description protocol), and WSDL (Web Services Description Language) with Java enabled Client.

The eWom Marketing Media & API systems have core components such as: eWom Marketing Media Server with KeyID Logging & Tracking 1300; KeyID Log & Indexing 1310; SIP Server with SDP to IMS 1305; Advocate Index Connect 1315; E-Procurement API Services & Settings 1325; Access and Policy Control 1320; eWom Marketing Media Database 1335; Campaign Marketing Tools 1340; IMS Media Channel Settings 1330; API Software Development Kit (SDK) Layer with Service Connect and User Interface Tools 1350; Buy-Sell Auction Interface Tools 1355; Marketing Tracking System 1320; and Trust & Expertise Ranking and Tracking 1370.

The SOAP with KeyID Service sends SOAP requests and receives SOAP responses over Hypertext Transfer Protocol (HTTP); a SOAP API is developed for and by E-Procurement Providers (in Java, Visual Basic or C++); a Web Server 1300 receives SOAP requests and gives responses to the SOAP KeyID Service; in order to parse both the HTTP header and SOAP messages sent from the Web server contain a SOAP Server 1300; a SOAP Server 1300 (or a SOAP Engine) parses SOAP request messages and invokes the appropriate Web Service then generates a SOAP response messages to SOAP KeyID Service; AXIS version 3 of Apache SOAP in which Java is used to implement standard SOAP is implemented; Axis is the SOAP server to be used in the system; Web Services provide services for the Service Providers clients to use and the functions of the services are based on the business requirements; services have back end database connectivity and development support. Web service programs can be developed in Java, C++, and Visual Basic as well as other languages. The embodiment envisioned here uses Java.

The platform provides a series of tools and services for any eWom Marketing Media applications. When the user has registered and activated services the system provides many useful processes and tools available including Data Connect Objects for API Layers with: layer creation; layer editing; layer testing; layer ownership transfer; layer publication; and layer services design and connect.

The API Software Development Kit (SDK) with Service Connect and User Interface Development Tools 1350 provides the E-Procurement User with object templates for quick access to the core databases within the invention. The developer registers and requests the API Key for each project to link the API Database Connect into the developed layers.

The combination of the eWom Marketing Media Server and KeyID Logging services provides a direct tool for E-Procurement Users to maximize results. The KeyID Log and indexing provides information for tracking marketing campaigns and results in real time. A more complete explanation of the services that can be access and used are in the FIG. 14 description.

FIG. 14 illustrates a generalized description of a Viral and Marketing Tracking System with Double-Hermeneutics and Semantic Services of the invention in accordance with various embodiments described herein.

The tremendous power of the eWom Automated Advocate Marketing Platform with KeyID is no more evident than in this simple example. With the use of eWom and the ability to track this system can do things no other system in the world is able to at this time. It can track viral marketing campaigns and actively interact with the Viewer to determine a purchase even without an online e-commerce confirmation action. This can be derived from many different processes but one simple example is outlined in FIG. 14.

The eWom Marketing Media Server with KeyID Logging & Tracking FIG. 13 processes all eWom hyperlink requests and indexes all KeyID's into a Log and Indexing File FIG. 13. The Viral and Marketing Tracking System FIG. 14 provides the input for the recording and activation of KeyID actions.

Stochastic process or states determined within the Core Logic Engine FIG. 2 both by the processes of predictable actions and by a random element such as a text. The information retrieval and extraction engine combined with the RLSI extracts Key Words associated with Viewer actions to find actionable events not measurable with the current model. Instead of dealing with only one possible measure this process provides a Key Word based model to confirm purchases outside of the traditional online metrics. All these stochastic related processes and data assist in identifying the characteristics and indexing for the global relational graph system.

An eWom is displayed 1400 on a website Ad based on a lookup into the KeyID Log & Indexing (shown in FIG. 13). The Viewer who is identified through the User, Device Discovery Gateway with eWom Marketing Media Lookup (FIG. 12) clicks through the Display Ad 1405. The regularized latent semantic index creates a Key Word 1410 through the Core Logic Engine. The Viewer has accepted an invitation from an Advocate and downloaded the Web-Harvest Java API which scrapes the query and IM input and sends to the Core Logic Engine. The IM Key Words 1415 are parsed and populated into the eWom Marketing Media Server (FIG. 13). Instances or Actions 1420 are recorded with the KeyID of the Viewer or user. A Rating 1425 is derived from the semantic and double-hermeneutic valuation of the textual input from all sources including online many-to-many platforms.

The database works on an object oriented platform mapped to the Core Logic Engine (FIG. 2) and structured schema to the latent semantic indexing format. An actionable event occurs and is recoded including date, AdID and sources 1430. Object 2. 1440 displays the sources parameters recorded and the number of times for each Instance 1435.

The Double-Hermeneutics and Semantic processing based on scraped or parsed terms has identified KeyID Action Key Words 1445 that have identified core actions of the Viewer including Click Through 1405. A KeyID Action 1445 has created a Semantic Object 1455 and the Core Logic Engine FIG. 2 has recorded Instances 1450 to assess and determine the rating of the linguistic context of the possible action of the Viewer in terms of sale based on the Click Through 1405.

This process and its actions are tracked through the KeyID and eWom Marketing Media Server with KeyID Logging & Tracking FIG. 13.

The system through the Core Logic Engine FIG. 2 has a plethora of parameters and platforms to establish, identity, and track these Key Word actionable events, including the eWag eWom Marketing Media Database with Content Management Platform. Combined with KeyID and the Regulated Latent Semantic Indexing the system can track and identify transactions through the internet and indexed multimedia and electronic word of mouth properties from authors to publishers.

Further, the Advocate invitation system provides a point of identity for the viewer as does the Persistent Cookie, Java API and Persistent SAML ID Token. The Advocate Marketing Platform provides identity processes not available to any other system. The regularized latent indexing with KeyID provides an additional level of authentication beyond traditional SSO and UDID.

It should be noted that particular terminology when describing certain features or aspects of the invention should not be taken to imply that the terminology is being re-defined herein to be restricted to including any specific characteristics of the features or aspects of the invention with which that terminology is associated.

The above detailed description has shown Key Word with KeyID tracking through to linguistic actionable events, this novel features of the invention as applied to various embodiments is only a generalized example, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

### DESCRIPTION OF SPECIFIC EMBODIMENTS

The Description of Specific Embodiments is from a Viewers perspective. It should be obvious that this same perspective can be associated with any user profile and authorization. The Viewer has a unique position within this invention in they do not need to have a user account but simply a Viewer account which differs in functionality. The Viewer is a type of KeyID that is recorded in many different forms and allows the invention to Visualize the Advocate eWom Marketing Media within the Viewer's Advocate Network.

As described in the General Description of Embodiment the E-n Procurement User is an Advertiser, Ad Network, Publisher, Agency or E-Procurement Provider. They have access to tools to create and direct eWom Marketing Media and design Campaigns based on budget and expertise profile. The Buy-Sell Auction Platform provides an automated and real time application of marketing and once the transaction is completed the campaign defined by the E-Procurement Provider the system is fully automated. The E-Procurement Provider has full control of the message and channels and can adjust all variables at any time and the changes will take effect immediately.

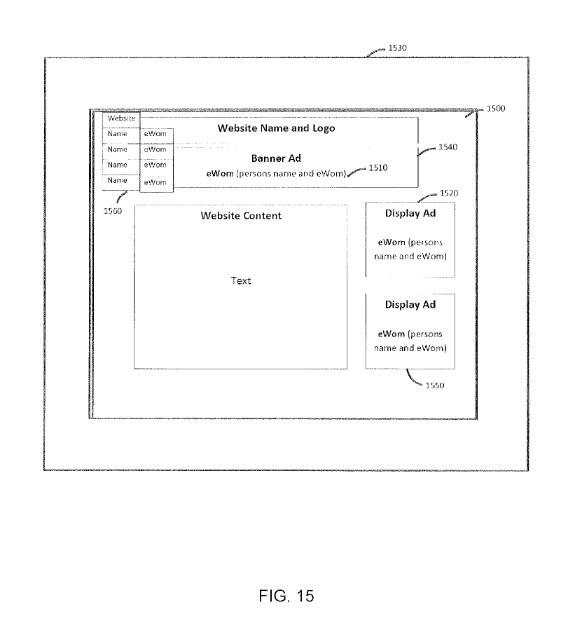

FIG. 15 is a simplified diagram of the Website Display Ads Virtualized and URL Pop-up eWoms of the invention in accordance with a specific embodiment described herein.

Advocates have registered eWom Marketing Media and advertisers or E-Procurement Users have purchased the Advocates eWom Marketing Media based on click-through actions.

When the website page 1500 is loaded it includes eWom eWag URL's ewom.domain.com/eWom#+Reg#+KeyID+AdID# 1510 that are loaded when the advertising 1520 is loaded and then makes a request to the eWom Marketing Media Sever for the eWom. The system pings the Display Device 1530 to check on the Viewers identity. The Viewer is identified through the User and Device Discovery Gateway system. Based on the KeyID Log and Indexing Lookup results the eWom Marketing Media is selected and Virtualized on the Banner 1540 and Display Ads 1550.

If the site is also being marketed using the eWom Marketing System a Java menu 1560 is Virtualized onto the website top frame for selection by the Viewer.

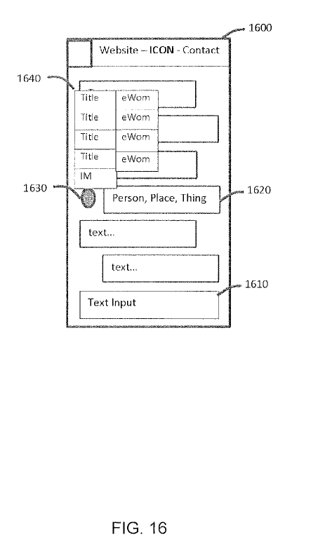

FIG. 16 is a simplified diagram of a Mobile Wireless Virtualization of eWoms, Icons, eWom Menus within an Instant Messaging Application of the invention in accordance with a specific embodiment described herein.

Advocates have registered eWom Marketing Media, and advertisers or E-Procurement Users have purchased the Advocates eWom Marketing Media based on Icon selection actions.

The Viewer is using a Mobile Device 1600 Instant Messaging Client 1610. The Viewer is looking for new music. An Icon appears 1630 within IM conversation 1620 next to one of the artists names. The identity and topic were derived from the Viewer's Global Graph and Semantic Indexing data combined with Hermeneutics. When the Viewer mouses over, or utilizes the multitouch display to visualize the eWom Marketing Media 1640 the system pulls the eWom menu 1650 based on a rated selection of Advocates in the Viewers Network.

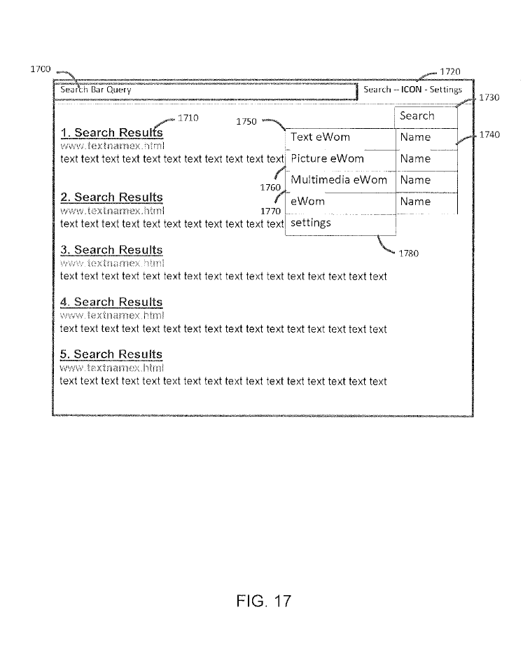

FIG. 17 is a simplified diagram of the Search Engine Virtualization of eWoms, Icons, and eWom Menus of the invention in accordance with a specific embodiment described herein.

Advocates have registered eWom Marketing Media for a specific Restaurant they like and advertisers who is a restaurant owner or E-Procurement User has purchased the Advocates eWom Marketing Media and allocated the majority to search engine queries 1700 which is processed in real time through a Java scraping and harvesting API loaded when the Viewer clicked on the Advocates Invitation and actionable event being click on the Advocates eWom Marketing Media in the Menu Virtualized when the Viewer completes that query.

The Viewer is searching for a restaurant and when the results appear 1710 an Icon is Virtualized on the address bar. The Viewer mouses over the Icon 1720 and a Menu 1730 appears with eWoms from Advocates they know 1740. The purity of eWom Marketing Media in the Menu is based on the Trust and Expertise ranking 1740. When the Viewer mouses over of the menu a secondary menu provides a dialog with a more complete view of the eWom Marketing Media 1750.

The eWom Marketing Media is in the form of text 1750, picture or a visit or event at the establishment 1760, and a multimedia recommendation with video 1770, Virtualized based on the Viewer's profile and preferences or manual settings 1780.

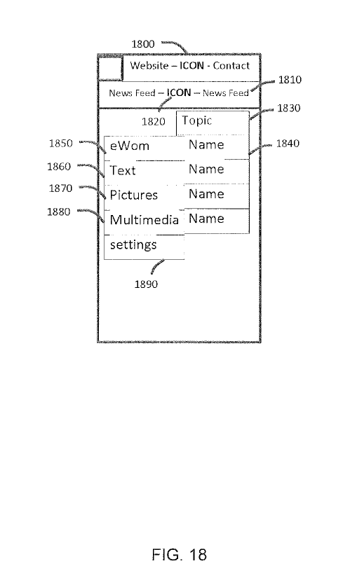

FIG. 18 is a simplified diagram of a News Feed Virtualization of eWoms, Icons, and eWom Menus of the invention in accordance with a specific embodiment described herein.

Advocates have registered eWom Marketing Media and advertisers or E-Procurement Users have purchased the Advocates eWom Marketing Media based on Icon selection actions.

The Viewer is using a Mobile Device 1800 with News Feed 1810. The Viewer is watching the News Feeds and notices a Travel Destination with an Icon 1820.

The Viewer mouses over the Icon 1820 and a Menu appears 1830 confirming Topic. A list of people the Viewer knows that have listed eWom's appears 1840 and the system pulls the eWom menu 1840 based on a rated selection of Advocates in the Viewers Network.

The eWom 1850 Marketing Media is in the form of text 1860, picture or a visit or event at the destination 1870, and a multimedia recommendation with video 1880, Virtualized based on the Viewer's profile and preferences or manual settings 1890.

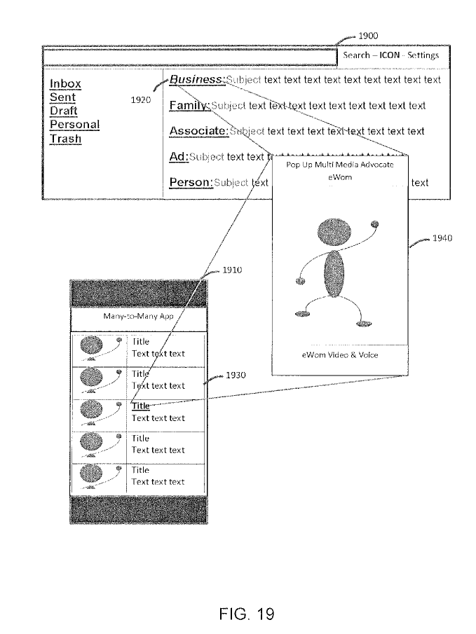

FIG. 19 is a simplified diagram of E-Mail and Many-to-Many applications Virtualization of eWoms, Icons, and eWom Menus of the invention in accordance with a specific embodiment described herein.

Advocates have registered eWom Marketing Media and advertisers or E-Procurement Users who are Professionals have purchased the Advocates eWom Marketing Media based on subject selection actions.

A Professional has registered as an E-Procurement User to purchase Advocate eWom Marketing Media which has been identified during Latent Semantic Indexing or Java Scraping and Harvesting processes. The Topic or Title is highlighted with an eWom Marketing Media link ewom.domain.com/eWom#+Reg#+KeyID+AdID# to a multimedia pop-up presentation from a supporting and Trust and Expertise qualified Advocate within E-Mails Applications 1900 and Many-to-Many Communication Platforms 1910.

When the viewer mouses over or clicks on the Subject 1920 or Title 1930 a multimedia presentation appears 1940 based on the Viewers KeyID. This connects the Viewer with the Professional and business opportunities.

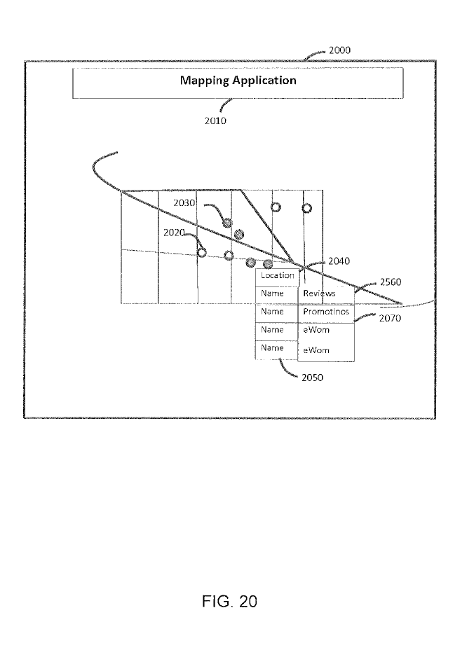

FIG. 20 is a simplified diagram of a Mapping Application of Virtualization of eWoms, Icons, and eWom Menus through Mouse Over or Touch Screen Activation of the invention in accordance with a specific embodiment described herein.

Advocates have registered eWom Marketing Media and hotel advertisers or E-Procurement Users have purchased the Advocates eWom Marketing Media based on mouse over or selection actions on a Mapping Application.

The Mapping Application 2010 displays hotels that are available based on the search criteria the Viewer used. The Java Scraping and Harvesting System identifies the hotels 2020 and advertising eWom Marketing Media purchased by the company or establishment by highlighting 2030. When the Viewer mouses over or selects a hotel that is highlighted the eWom Marketing Media is presented in a menu 2050 when there is more than one eWom for that Viewer based on the Viewers KeyID.

The eWom Marketing Media menu identifies the location 2040 and reviews 2060 or promotions 2070 that are not publicly known and provide Viewers with real world information based on the Advocates in their Global Graph.

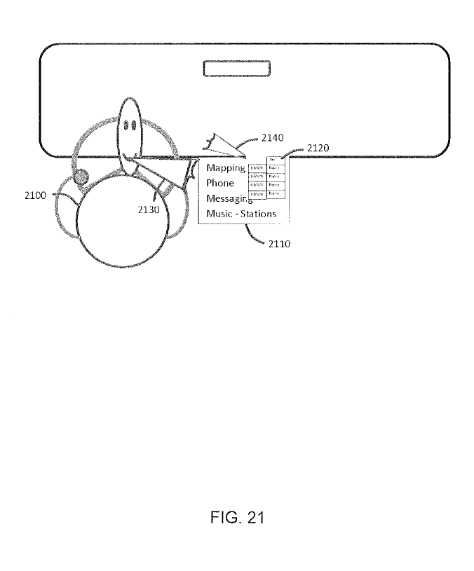

FIG. 21 is a simplified diagram of a voice eWom application in a motor vehicle of the invention in accordance with a specific embodiment described herein.

### Messaging, Music and Mapping Example

As an example, assume Advocates have registered eWom Marketing Media and Advertisers or E-Procurement Users have purchased the Advocates eWom Marketing Media based on voice response actions.

The vehicle owner 2100 needs to find a place to meet a date and asks the voice activated mapping application 2110 where the entertainment spot is including movies, restaurants, coffee house and other service providers. The system uses GPS to locate 2120 and the drivers KeyID through Voice Recognition 2130 to find the eWom Marketing Media and deliver voice recommendation 2140 by text to voice or voice recorded advocacy statements.

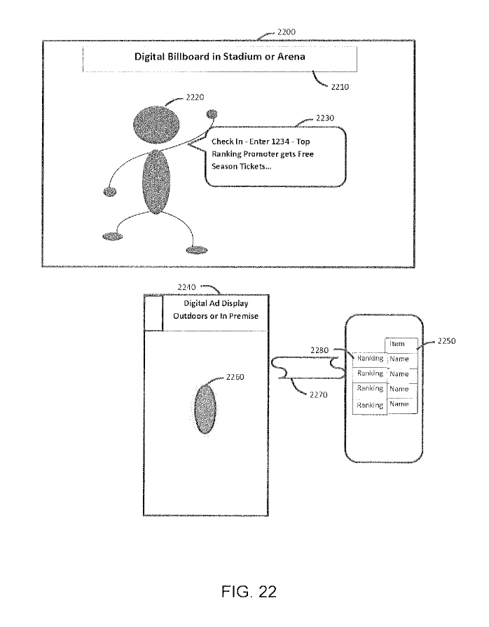

FIG. 22 is a simplified diagram of a Digital Billboard and Outdoor Ad Display Virtualization of eWoms and Mobile Devices Icons, eWom and eWom Menus of the invention in accordance with a specific embodiment described herein.

A Sports Team 2200 has decided to acquire the most Advocates of any Sports Team in history. They have a two pronged approach. One is to get as many in the stadium 2200 as possible to register as Advocates and the second is to create revenue by having the Advocates look for the Season Tickets on Outdoor or In-Premise active advertising media 2240. The Sports Team utilizes the MPLS (Multi-Protocol Label Switching) Transport system of the eWom Marketing Media Gateway.

Sports fans enter the code 2230 in the sports team application. The Viewers are given an opportunity to find the Active Ad Displays 2240 in the Stadium with the Free Season Passes. The Outdoor and In-Premise Active Ad Displays 2240 use Near Field Wireless 2270 and KeyID to find the top ranking Advocate 2250. As the Advocates look at new Active Ads 2240 ranking 2280 increases as does ranking based on new Viewers within the Advocate Viewer Network.

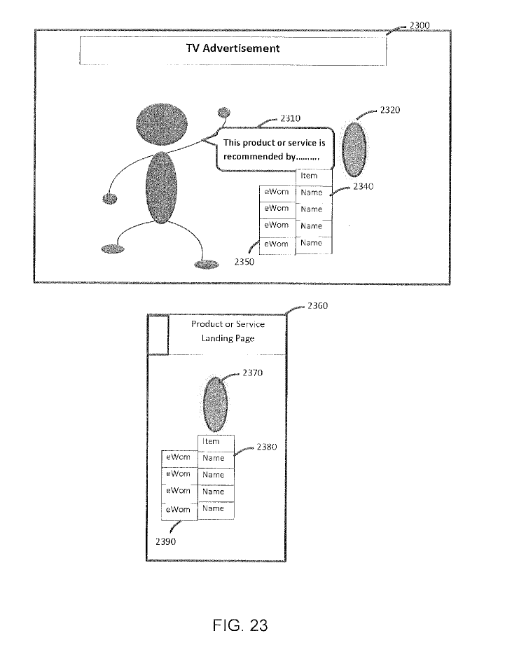

FIG. 23 is a simplified diagram of the TV eWom recommendation and Audio Watermarking Activation of Virtualization of eWoms, Icons, and eWom Menus of the invention in accordance with a specific embodiment described herein.

In this embodiment the system utilizes the IMS MPLS (Multi-Protocol Label Switching) Transport system for direct interaction with the Television (TV) and Entertainment Center 2300. Within the Advertisement an interactive eWom is Virtualized 2310 with Recommended by [name} in the TV and Multimedia Commercial and Menu can be expanded with remote control input to reveal names of eWom Marketing Media providers 2340 and eWoms' 2350. This recommended by is created by identifying the Entertainment System Owner either by registration into the Advocate Marketing Platform or through interactive responses through the remote control. The product or service provider 2320 has initiated an Audio-Watermarking within the Audio Track that activates a Product or Service Landing Page 2360. This activates the KeyID Lookup system which identifies Advocates the Viewer has in their Viewer Network Graph or Profile. The product or service 2370 is presented along with an eWom Icon and menu with names 2380 and eWom's 2390.

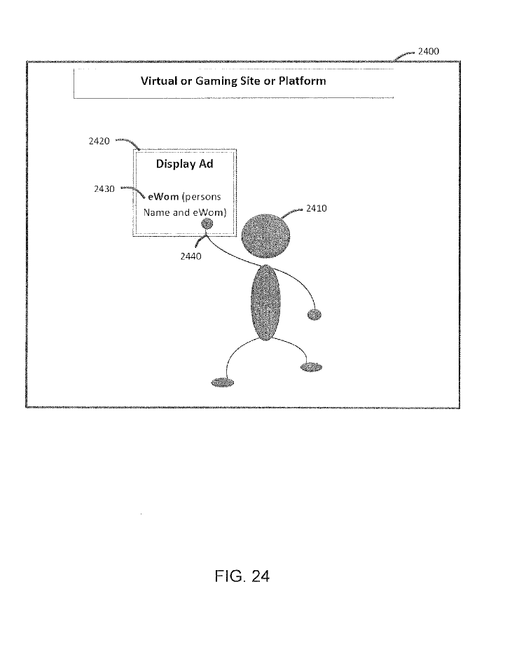

FIG. 24 is a simplified diagram of a Gaming and Virtual Environment Virtualization of eWoms, Icons, and eWom Menus of the invention in accordance with a specific embodiment described herein.

The user registers his character in the Massive Multiplayer Online Role Playing Game (MMORPG) world 2400 and Digital Rights Registration Database with a Virtual Character 2410 KeyID. The game architecture includes plug-ins for Ad Virtualization in the virtual environment written in C# or similar language with virtual Ads 2420 connected through the TCP/IP Packet Switching connection and provides eWom's related to the users Advocate Network.

The user starts playing the game and clicks on an Advertisement 2440 and it sends a link to the users account or opens up a window to a new world. The eWom Marketing Media message 2430 is displayed within the virtual game environment in real time utilizing the IMS Packet Switched system and the Virtual Character KeyID.

The score can also be tracked and based on all other scores can be added to the Expertise Ranking in the Trust and Expertise Ranking System. This power can provide a buy-sell of powers through the Buy-Sell Auction Platform and other value added powers including weapons and skills.

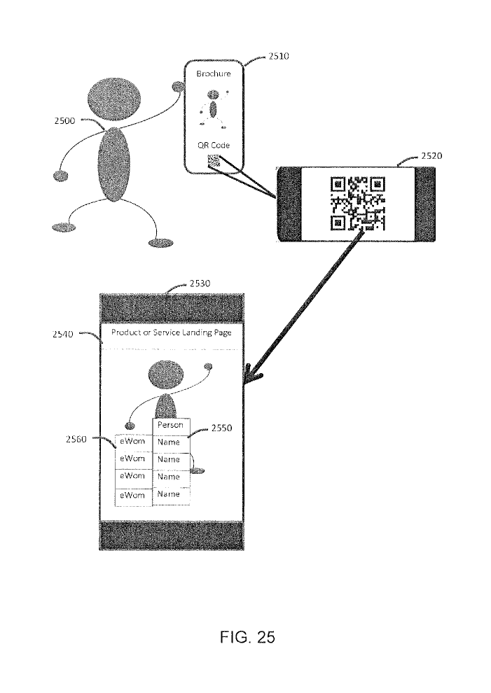

FIG. 25 is a simplified diagram of the Physical Brochure to

Activation of Virtualization of eWoms, Icons, and eWom Menus on a Landing Page or Website of the invention in accordance with a specific embodiment described herein.

A Professional or Agent such as a Real Estate Agent 2500 creates a physical brochure with link, QR or similar code 2510. The Real Estate Agent passes out the brochures to promote his business. When the recipient receives the brochure and scans the QR or similar code 2520 or enters the website link and the system opens the landing page 2530 with the promotion 2540 and executes a Viewer KeyID search for eWom Marketing Media to Virtualize on the mobile device. The eWom Marketing Media is found and people known by the Viewer 2550 provide recommendations for their product or service 2560.

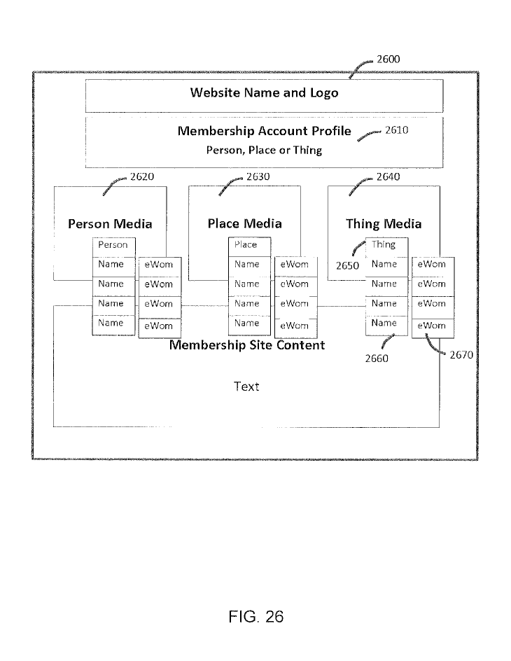

FIG. 26 is a simplified diagram of a Membership Person, Place or Thing Site with Private eWom Displays Virtualization of eWoms, Icons, and eWom Menus of the invention in accordance with a specific embodiment described herein.

The many forms of Membership Sites 2600 including sites focused on person, places and things and with applications for you to identify your desire but without control outside of that system. This invention allows you to do this with a private eWom anywhere anytime. The same process can be applied to a commercial eWom or eWom Marketing Media on any media and any account 2610.

Many forms of Person 2620, Place 2630 and Thing 2640 Media are through the digital or online world. Many people would like to leave private comments 2650 without having to work through another platform. With this invention a Viewer has this tool.

The Viewer can leave a private message for any Advocate in their Network. The Advocate Name 2660 and eWom 2670 can be Virtualized by simply mousing over the online Media.

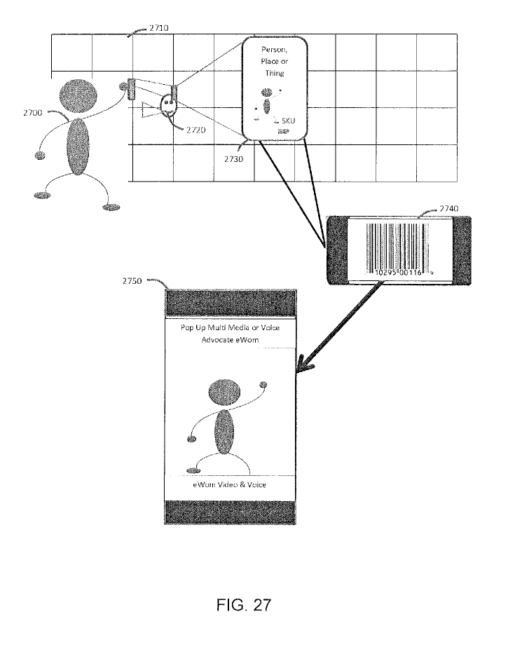

FIG. 27 is a simplified diagram of the Voice Advocate eWom system with Virtualization of eWom Menus of the invention in accordance with a specific embodiment described herein.

A shopper 2700 visits a Merchant 2710 and sees a pop out 2730 of a product or service they would like to buy. They scan in the SKU or Code 2740. The eWom Marketing Media Serve utilizing the Viewer KeyID to find eWom Marketing Media from Advocates within their Viewer Network finds the eWom Marketing Media. A Dialog Pops up on their Mobile Device 2750. The system checks the eWom and though Near Field Wireless and Virtualizes an eWom Marketing Media over a voice system 2720 at the Merchant.

This can be applied to any person, place or thing through any media channel with any method of activation utilizing this invention.

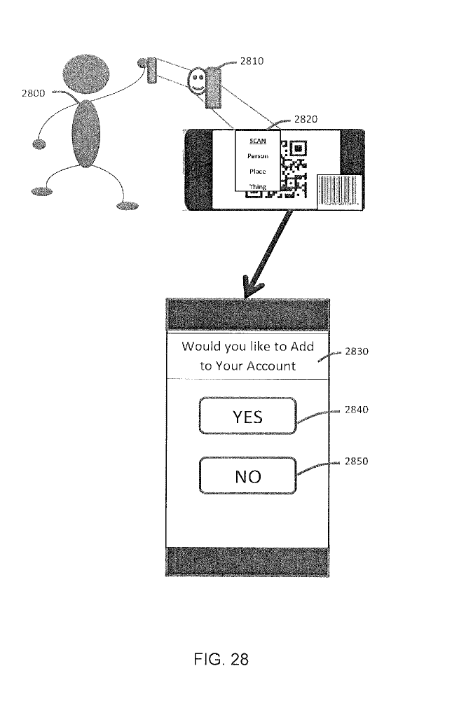

FIG. 28 is a simplified diagram of the Get/Want/Wish-List SKU, QR, Code or Scan Mobile system for placement of Person, Place or Thing into the User Account of the invention in accordance with a specific embodiment described herein.

Any User of the Advocate Marketing System and Platform can us this process to place or pin person, places or things into the Advocate, Viewer or E-Procurement Account. The process of placing the account can include scanning, recording, visualization and any other form of input and this media, product or services, professional or service provider placed into a User Account.

In this specific embodiment a user 2800 with a mobile device 2810 scans a product 2820 and the mobile device detects the owner 2830 based on KeyID and asks whether the user wishes to add to the account, Yes 2840, No 2850. This simple process allows users to populate accounts with people, places or things they wish to purchase or promote and the system upon receipt into the account works through all platforms including Topical Indexing, Global Graphs, and eWom Content Pages to find possible opportunities to promote or to buy. The possibilities are unlimited as are the marketing tools.

The foregoing description details certain embodiments of the invention. It will be appreciated, however, that no matter how detailed the foregoing appears in text, the invention may be practiced in many ways and in any combination of descriptions provided.

It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A system and method for advocate marketing with digital rights registration is envisioned. An information and extraction engine creates a topical semantic indexing platform for recording and indexing eWom and multimedia content and properties. The system provides indexing to a content management and public platform for indexing throughout the online system and search engine. An eWom hyperlink is generate through the process of monetization and delivery of the eWom marketing media and includes a KeyID for global online and linguistic tracking. The advocate marketing system uses multiple unique global and social graphs to populate a global relational graph system for optimization of commerce processes. The digital rights registration, trust and expertise ranking processes provide a method to establish monetization including through an automated buy-sell auction platform and ranking. An authentication, authorization, and device registration gateway provide authorization and authentication for services. An advocate and user graph acquisition and lookup system provides network indexing architecture and combined with KeyID universal device discovery. A digital rights registration system provides a record of ownership of digital rights. The topical semantic indexing provides search engines with a focused multimedia indexing platform. The buy-sell auction platform provides monetization through purchases from viewers, advertisers, ad networks, agencies and suppliers. A core logic engine optimizes operation and performance with a polymorphic database and indexing schema. Programmable algorithms are used for system optimization and management including information retrieval and extraction. The core logic engine provides modeling and delivery of trust and expertise ranking utilizing viewer and network user input for trust, topical semantic indexing and performance for expertise calculations. An next generation network media channel gateway provides automated delivery of marketing media through all types of networks and platforms. The combination of the semantic topical indexing, eWom tagging processes, KeyID, probabilistic and non-probabilistic, multiple global relational graph architecture with online extraction techniques provide a comprehensive tracking of all marketing campaigns including eWom and multimedia. An API (application programming interface) platform and SDK (software development kit) integrated into the advocate marketing system for provides plug-in architecture for future media, delivery technology, product and service developments.

2. The system recited in claim 1, wherein virtualization of eWom's is provided on digital media.

3. The system recited in claim 1, uses a virtualization platform to add eWom's to physical marketing media utilizing a scan coding for mobile or wired devices through SKU or QR codes to activate digital wireless and wired online presentations of eWom's from physical marketing media.

4. The system recited in claim 1, wherein uses a virtualization platform to add eWom's to virtual and gaming environments such as MMOG and MMORPG to display, voice, text and multimedia eWom presentations within those environments.

5. The system recited in claim 1, wherein uses a digital rights tracking system to identify unauthorized use of registered eWoms.

6. The system recited in claim 1, wherein an indexing platform records and indexes digital eWom and multimedia properties.

7. The system recited in claim 1, wherein a multi global graph system identifies relations and defines and optimizes commerce between users.

8. The system recited in claim 1, wherein the expertise ranking is enabled through indexing of eWom and multimedia properties by topical indexing with performance tracking.

9. The system recited in claim 1, wherein the KeyID system provides tracking of marketing through all channels and all media with key word discovery.

10. The system recited in claim 1, wherein the system is an independent platform or integrated data exchange for social, membership and service websites.

11. The system recited in claim 1, wherein utilizes a key word or words and/or event based discovery process to deliver eWom's to multimedia properties.

12. The system recited in claim 1, wherein uses an aggregate of social, membership, and service contact import or connect programs to populate the user's database.

13. The system recited in claim 1, wherein utilizes an eWom template for selection of preconfigured eWom's for marketing campaigns.

14. The system recited in claim 1, wherein eWoms are placed into a buy-sell auction system

15. The system recited in claim 1, wherein uses an anonymous device identification which combined with a persistent cookie, unique device identifier, or other ID method such as single sign on or through social, membership or service accounts high accuracy viewer related eWoms including within viral and guerilla marketing campaigns.

16. The system recited in claim 1, wherein utilizes a unique relational parallel graph based system of two or more unique global graphs for determining market media type and delivery channel along with device discovery.

17. The system recited in claim 1, wherein a viral indexing system utilizing the information and extraction and retrieval engine to identify routes and results with tracking of real actions from users including instant messages with probabilistic KeyID identification.

18. The system recited in claim 1, wherein auto matches eWom listings to advertisement, ad networks, agency and other listings to delivers real time notification of marketing media and performance metrics through all digital and messaging channels.

19. The system recited in claim 1, wherein a core logic engine utilizes a programmable algorithm and indexing module and system as well as system intelligence polymorphic algorithm and indexing system.

20. The system recited in claim 1, wherein uses a multicast or multi-channel delivery platform for detection and selection of network channels for delivery of eWom's for virtualization onto marketing media including connections through wire and wireless services and devices or through connection channels created and enabled by SDK and API's.
